(19) United States
(12) Patent Application Publication
(10) Pub. No.: US 2011/0063997 A1
(43) Pub. Date: Mar. 17, 2011

(54) INTERWORKING BETWEEN WIMAX AND 3GPP NETWORKS

(76) Inventors: Laurence Gras, Bures Sur Yvette (FR); Bruno Mongazon-Cazavet, St. Michel-sur-Orge (FR); Francois Taburet, Montrouge (FR)

(21) Appl. No.: 12/676,891

(22) PCT Filed: Sep. 8, 2008
(86) PCT No.: PCT/IB2008/003108

§ 371 Date: Dec. 1, 2010

Related U.S. Application Data
(60) Provisional application No. 60/967,809, filed on Sep. 7, 2007.
(60) Provisional application No. 60/967,817, filed on Sep. 7, 2007.
(60) Provisional application No. 60/967,866, filed on Sep. 7, 2007.
(60) Provisional application No. 60/997,126, filed on Oct. 1, 2007.

(51) Int. Cl. H04W 36/00; H04W 16/00; G06F 15/177

(52) U.S. Cl. 370/254; 370/331; 709/222

(57) ABSTRACT

One object of the present invention is an architecture for interworking between WiMAX and 3GPP networks, said architecture comprising: an interworking node IWK which connects with the 3GPP Packet Core Network using 3GPP Gi interface, face, and with the WiMAX Connectivity Service Network CSN using WiMAX R3 interface.

The present invention generally relates to mobile communication networks and systems.

Detailed descriptions of mobile communication networks and systems can be found in the literature, such as literature published by standardisation bodies.

One example is WiMAX, a description of which can be found in particular in IEEE 802.16e and WiMAX Forum standards.

In WiMAX, a Mobile Station MS has access, via an Access Service Network ASN, to IP services provided by a Connectivity Service Network CSN. ASN is defined as a set of network functions needed to provide radio access to a WiMAX subscriber. CSN is defined as a set of network functions enabling IP connectivity and WiMAX services to WiMAX subscribers. ASN includes entities such as Base Station BS and ASN Gateway ASN GW. CSN includes entities such as AAA Server, DHCP Server and Home Agent HA. Different interoperability Reference Points are defined, such as in particular Reference Point R3 between ASN and CSN and Reference Point R4 between ASN GWs.

Another example is 3GPP (“3^{rd} Generation Partnership Project”), a description of which can be found in particular in 3GPP standards.

In 3GPP, a Mobile Station MS (or User Equipment UE) has access to IP services via an Access Network AN providing IP connectivity. The Access Network AN generally comprises a Radio Access Network RAN and a Packet Switched Core Network PS CN. The Packet Core Network includes entities such as SGSN (Serving GPRS Support Node), GGSN (Gateway GPRS Support Node), and HLR/HSS (Home Location Register/Home Subscriber Server). Different interfaces are defined, such as in particular Gi interface between GGSN and external Packet Data Network PDN. The external PDN is selected based on the requested APN (Access Point Name), provided by the user at PDP Context Activation procedure. Interworking between Packet Core Network and external PDN is specified in particular in 3GPP TS 29.061.

It is expected, in the near future, that mobile terminals will be able to access the Internet through various radio access technologies such as 3GPP, WiFi and WiMax.

It is also expected that mobile terminals will roam across different radio access networks in a seamless manner in single radio (one radio at a time) or multiple radio (multiple simultaneous radio at a time) modes.

In order to provide seamless roaming between the different radio networks, inter-working architecture and mechanisms must be defined. Although inter-working mechanisms are currently being defined by standardization bodies, none of them provide seamless roaming between heterogeneous networks based on a loosely-coupled inter-working schema. Current mechanisms impose inter-working elements of heterogeneous networks to implement simultaneously all the behaviours of the inter-working networks. Such an approach tends to increase complexity in the production, operation and deployment of network elements. In particular, this approach does not preserve independence and complementarities of each network because it requires each network to be provisioned in advance for heterogeneous inter-working with other networks. Such a provisioning will have to cope with existing commercial networks in places that would require drastic upgrade and might not be commercially suited depending on customer requirements.

The 3GPP SAE is under study to provide the mobility management procedures to handle mobility between 3GPP and non-3GPP accesses (3GPP R8-TS 23.402). This architecture is based on Mobile IP or PMIP, which offer low performances in term of delay. Unfortunately, this is not suitable for an optimized handover required by real time services.

It is also expected, in the near future, that mobile terminals will use long-term IP end-to-end data connections (i.e. video streaming) while roaming through various radio access technologies such as 3GPP, WiFi and WiMax. In order to allow portability and seamless handover of such IP end-to-end connections, a mobile terminal needs first to be assigned a common IP address (globally reachable) whatever the underlying access technology is. Unfortunately current radio access network standards provide separate and disparate methods to define and assign such an IP address to a mobile terminal. First, separation does not ensure uniqueness of the address, second, disparity involves different and possibly incompatible mechanisms to obtain the address.

WiMax Forum provides inter-working recommendations to other radio networks. As far as 3GPP is concerned, WiMax Forum indicates that the 3GPP network shall present itself as an ASN-GW node for inter-working purpose. Thus doing, the WiMax Forum recommends a tight coupling between the two networks.

This would allow handovers between 3GPP and WiMax networks but requires important modifications of existing 3GPP networks. Moreover handover mapping between the two networks is unspecified. This would also allow a common IP address configuration but requires important modifications of existing 3GPP networks. Such a tight coupling is not good enough because it might have too much impacts on existing commercial 3GPP networks already in place and will establish a tight relationship between possibly concurrent networks.

Generally, there is a need to improve interworking and/or mobility between different types of access networks, such as in particular WiMAX and 3GPP access networks.

The present invention in particular addresses such needs.

These and other objects of the present invention are achieved, in one aspect of the present invention, by architectures for interworking between WiMAX and 3GPP networks.

In an embodiment, said architecture comprises:

an interworking node IWK which connects with the 3GPP Packet Core Network using 3GPP Gi interface, and with the WiMAX Connectivity Service Network CSN using WiMAX R3 interface.

These and other objects of the present invention are achieved, in another aspect of the present invention, by methods for handover between WiMAX and 3GPP networks, using such architectures for interworking between WiMAX and 3GPP networks.

These and other objects of the present invention are achieved, in another aspect of the present invention, by methods for assigning a common IP address in WiMAX and 3GPP networks, using such architectures for interworking between WiMAX and 3GPP networks.

These and other objects of the present invention are achieved, in another aspect of the present invention, by methods for 3GPP network entry, using such architectures for interworking between WiMAX and 3GPP networks.

These and other objects of the present invention are achieved, in another aspect of the present invention, by entities, such as in particular Interworking node IWK, 3GPP Packet Core Network entity such as in particular GGSN, and Mobile Station MS, for such architectures and/or comprising means for performing such methods.

These and other objects of the present invention will become more apparent from the following description taken in conjunction with the accompanying drawings:

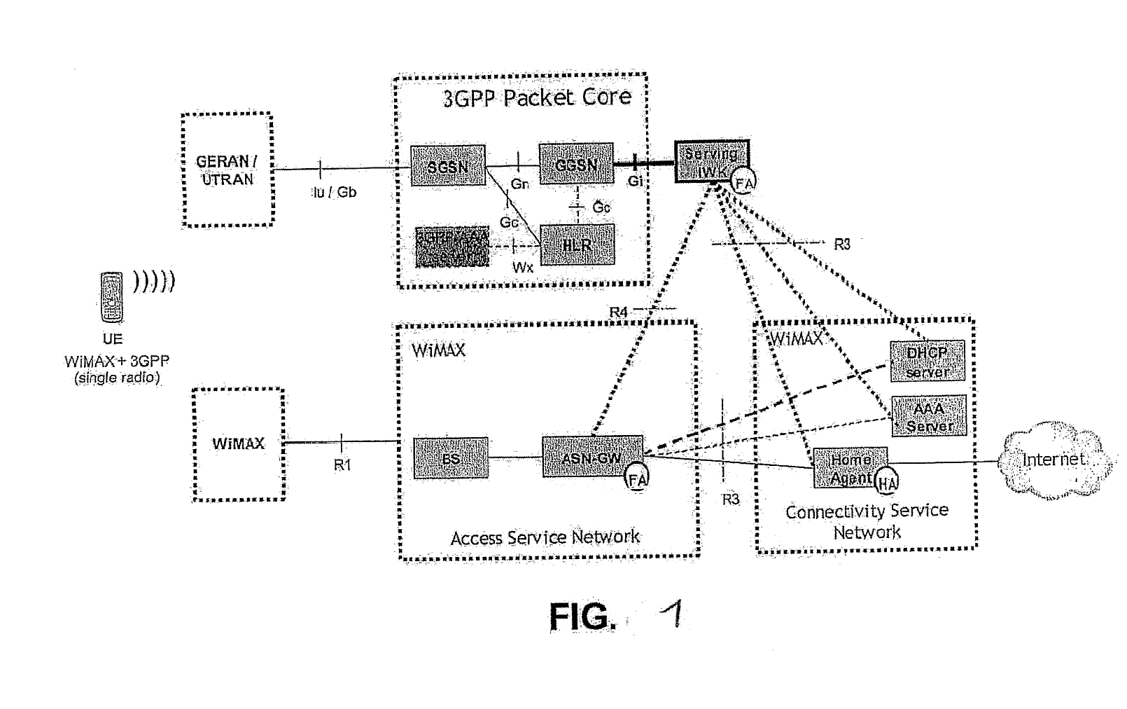

FIG. 1 depicts GSM-WiMAX inter-working overall architecture according to an embodiment of the present invention;

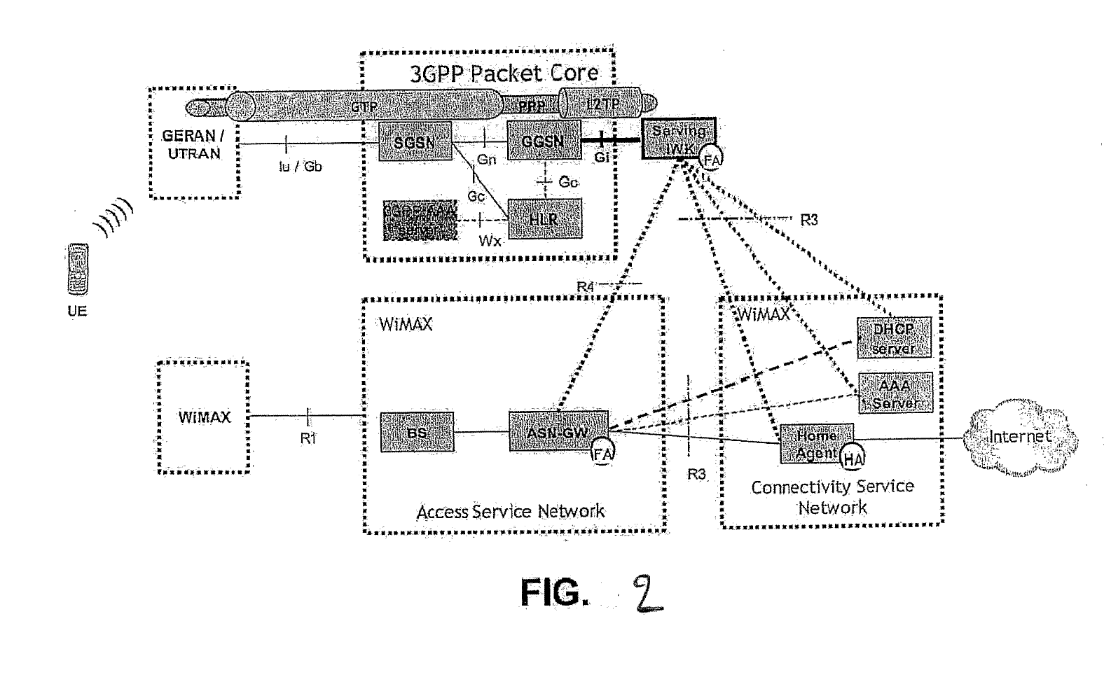

FIG. 2. depicts GSM-WiMAX inter-working, PPP PDP Context architecture, according to an embodiment of the present invention;

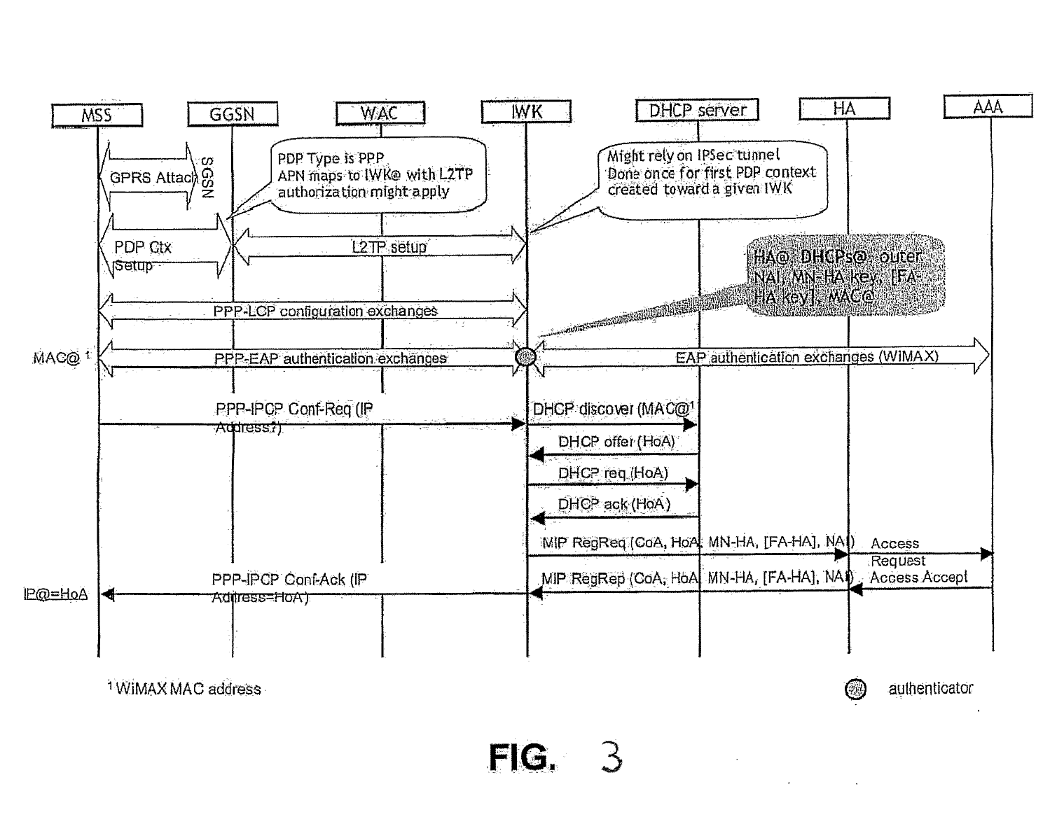

FIG. 3. depicts GSM-WiMAX inter-working, PPP PDP network entry (HoA obtained from DHCPs in WiMAX), according to an embodiment of the present invention;

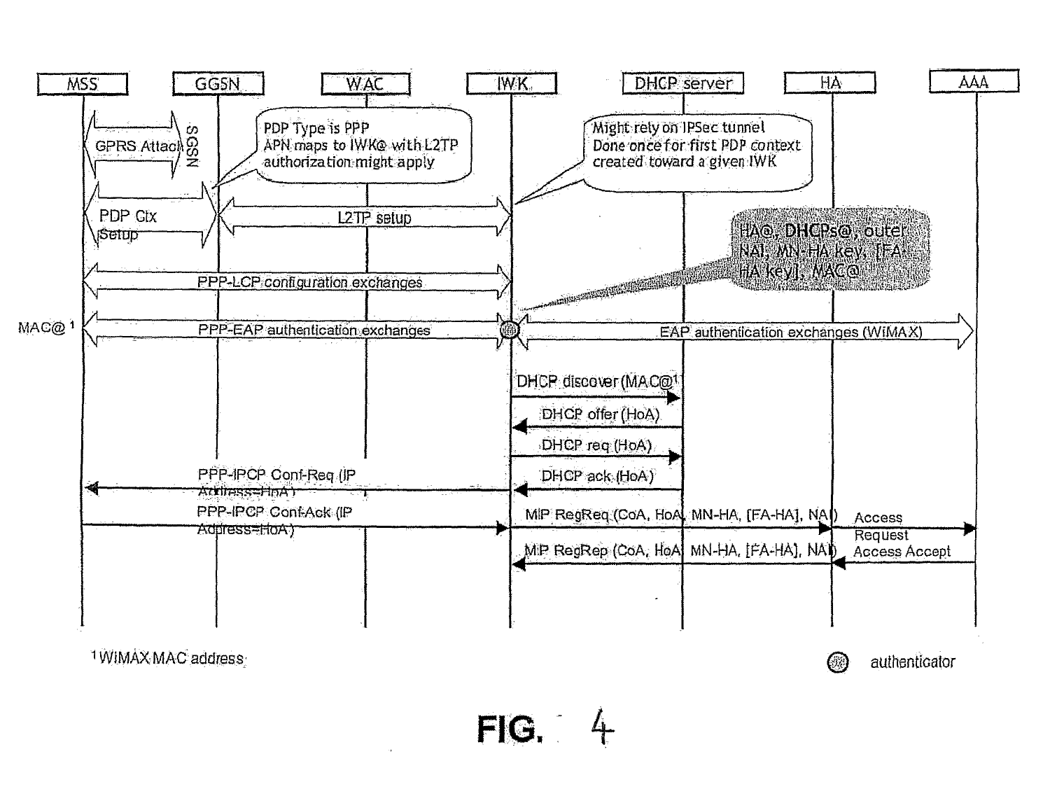

FIG. 4. depicts GSM-WiMAX inter-working, PPP PDP network entry (HoA pushed from DHCPs in WiMAX), according to an embodiment of the present invention;

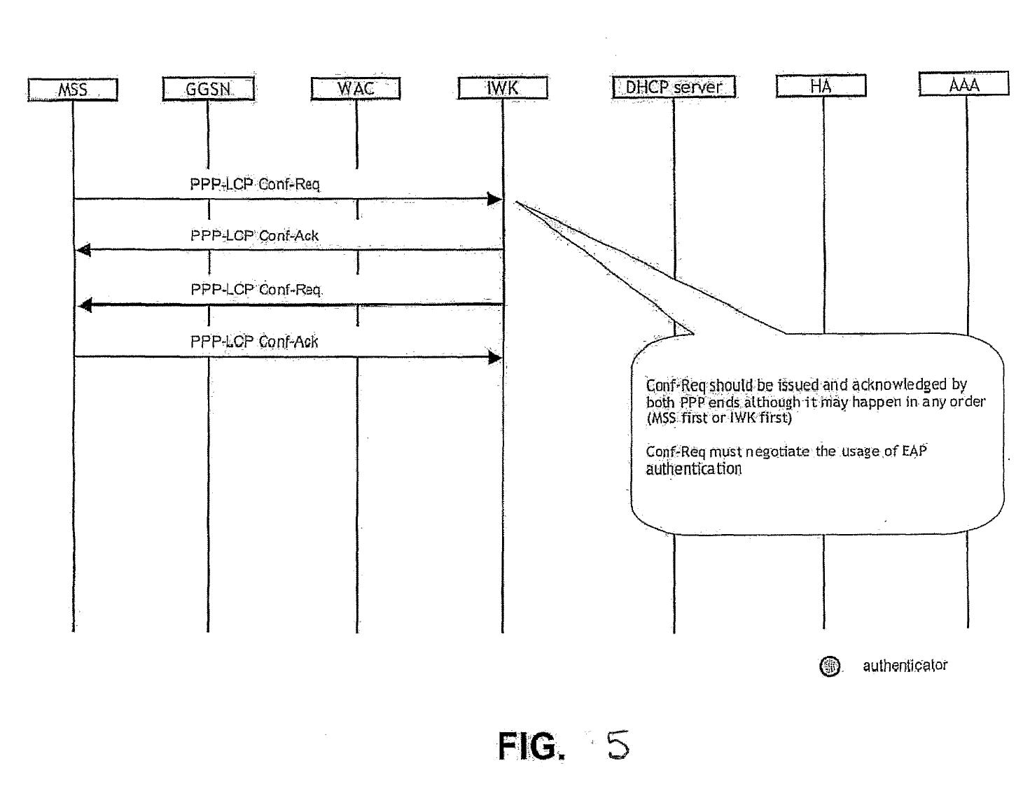

FIG. 5. depicts GSM-WiMAX inter-working, PPP PDP network entry (PPP-LCP configuration exchanges), according to an embodiment of the present invention;

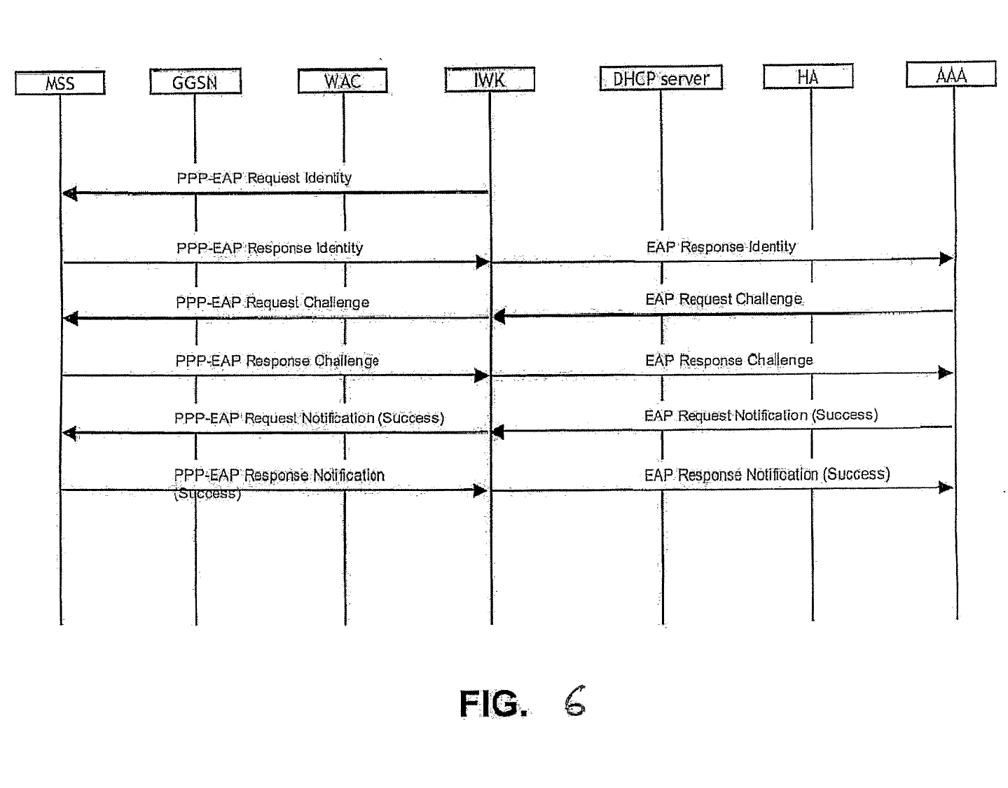

FIG. 6. depicts GSM-WiMAX inter-working, PPP PDP network entry (PPP-EAP authentication exchanges (Single user EAP-SIM authentication is detailed)), according to an embodiment of the present invention;

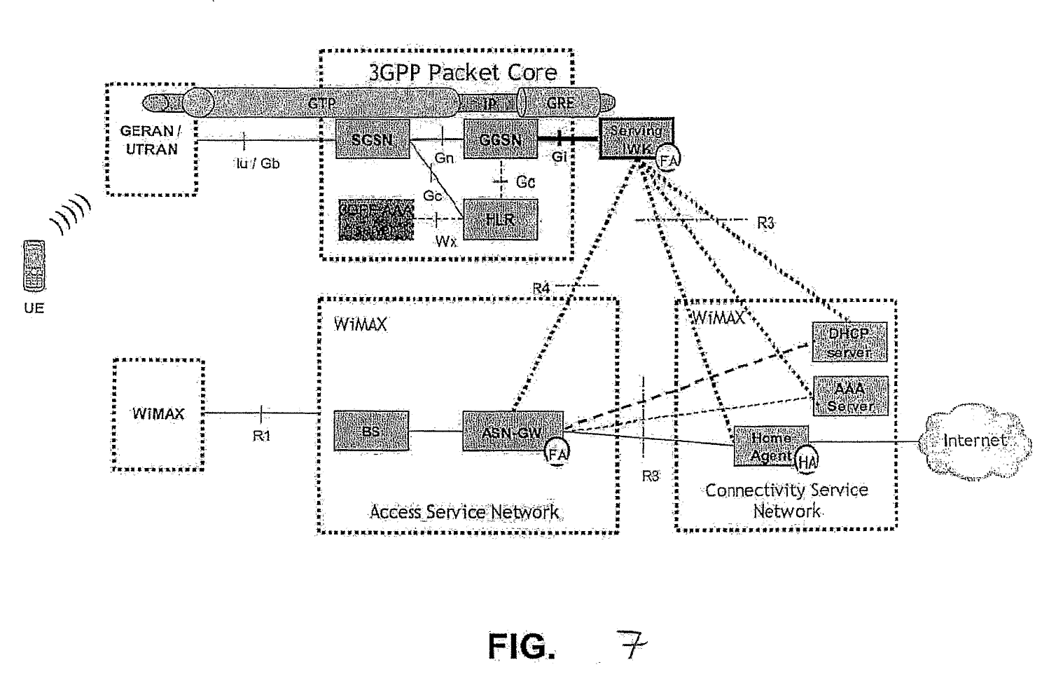

FIG. 7. depicts GSM-WiMAX inter-working, IP non-transparent PDP Context architecture, according to an embodiment of the present invention;

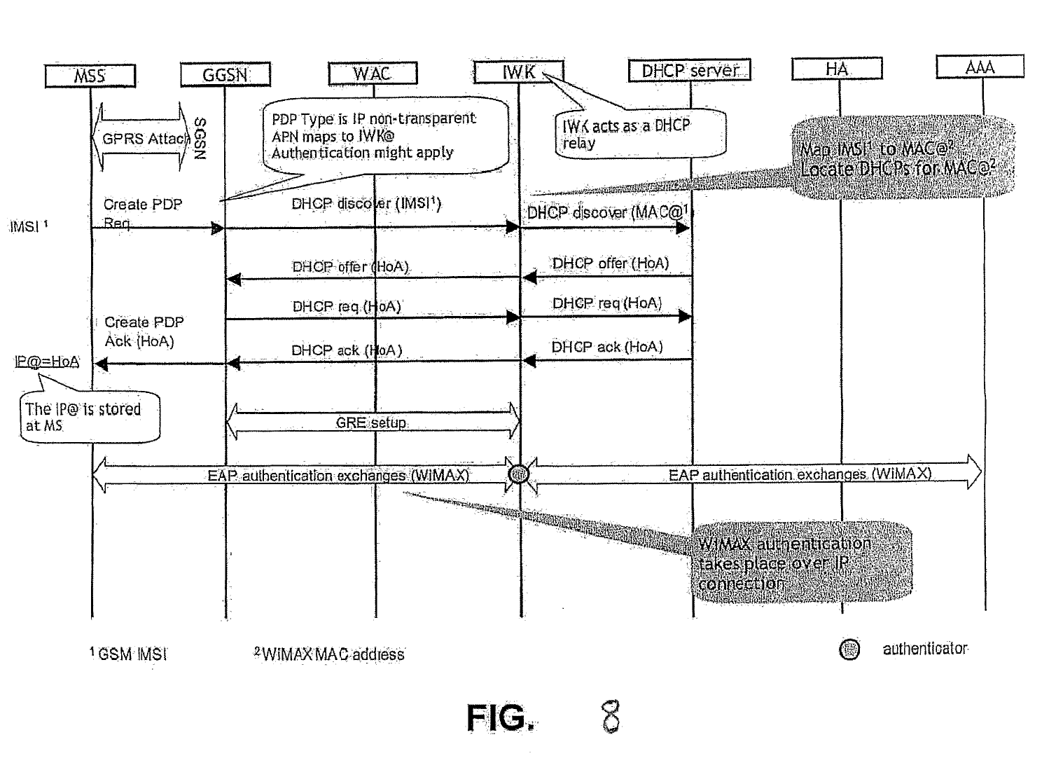

FIG. 8. depicts GSM-WiMAX inter-working, IP non-transparent PDP network entry (IMSI⇄MAC@ mapping), according to an embodiment of the present invention;

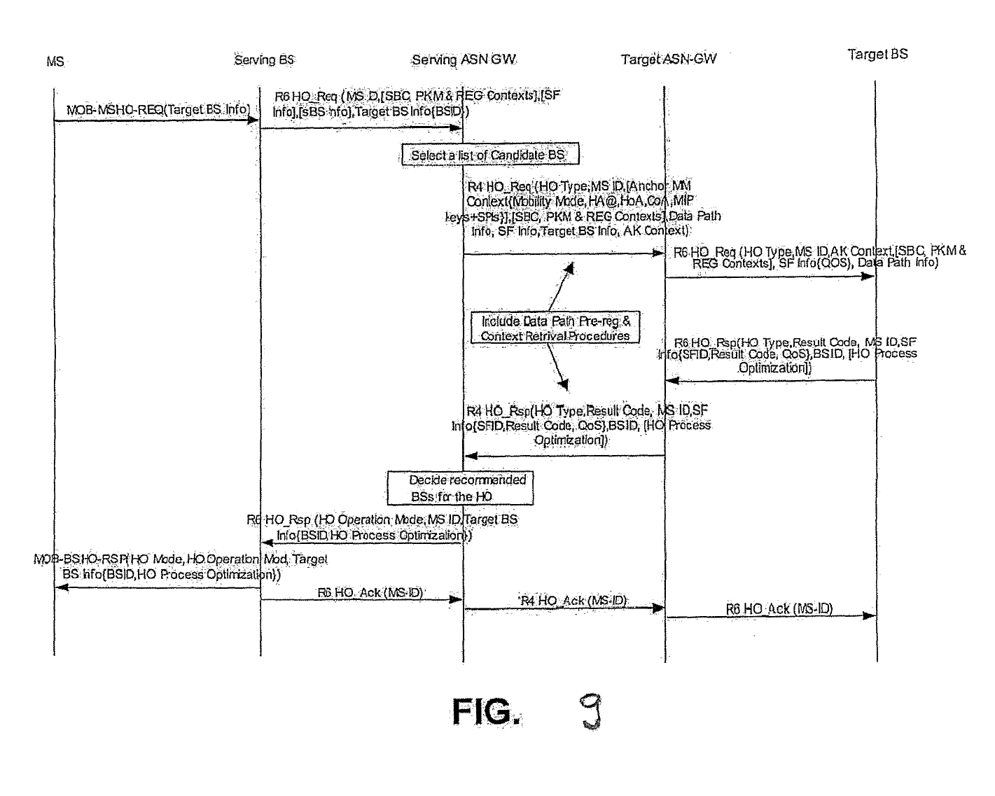

FIG. 9. depicts GSM-WiMAX inter-working, WiMAX HO Preparation (State of the Art);

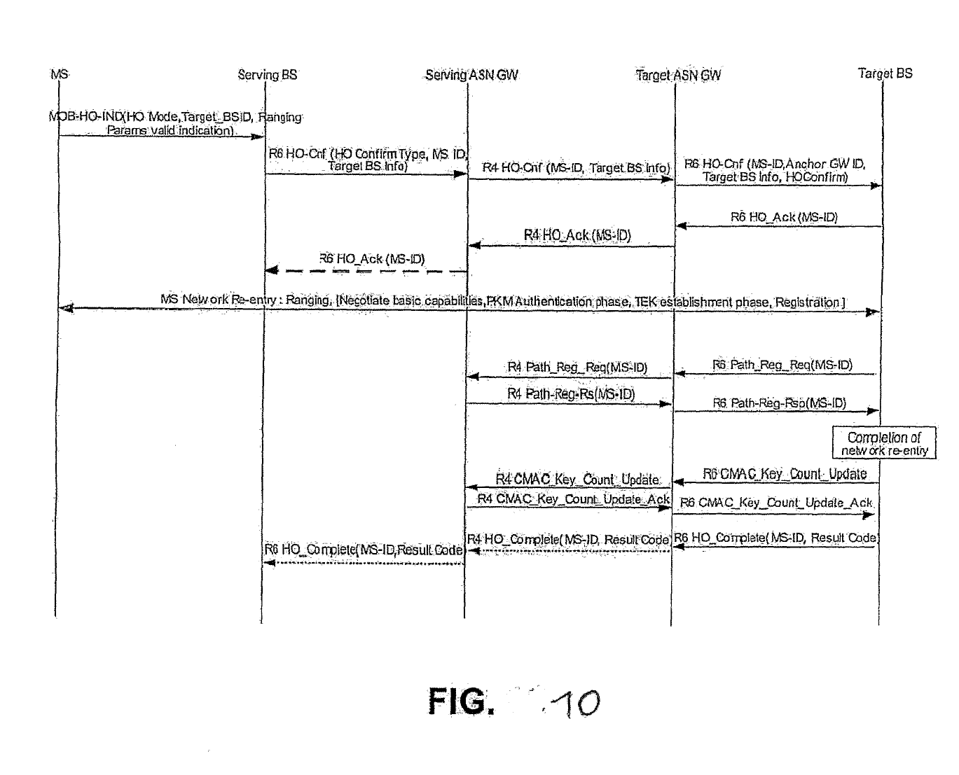

FIG. 10. depicts GSM-WiMAX inter-working, WiMAX HO Action (State of the Art);

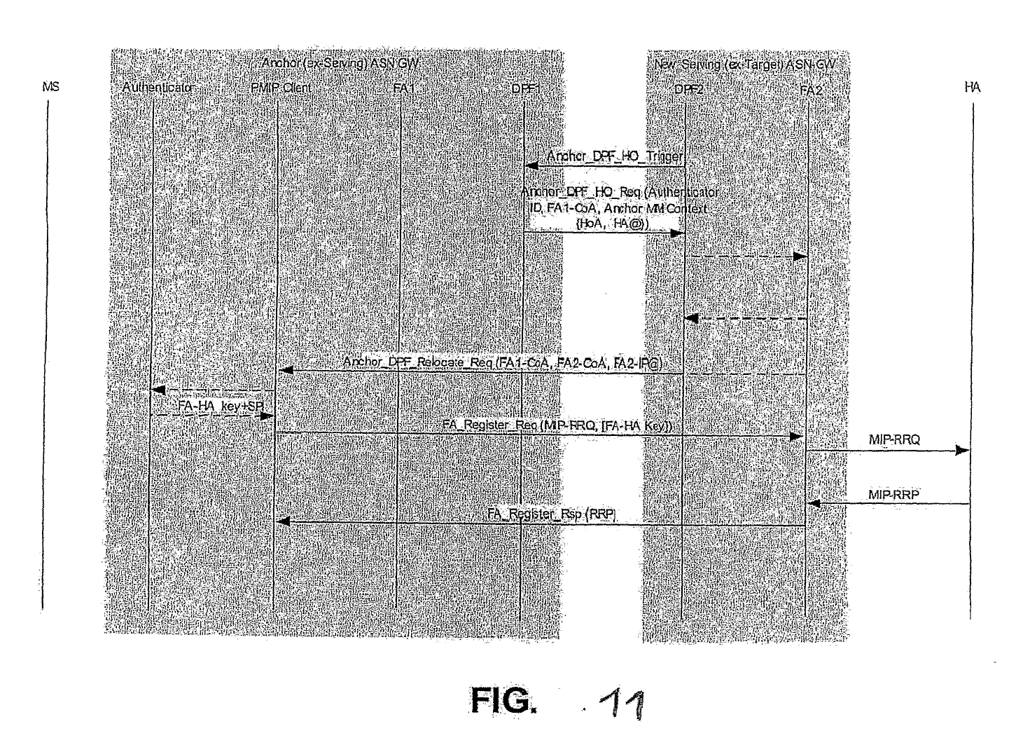

FIG. 11. depicts GSM-WiMAX inter-working, WiMAX PMIP HO Post-execution (State of the Art);

FIG. 12. depicts GSM-WiMAX inter-working, WiMAX→GSM HO, according to an embodiment of the present invention;

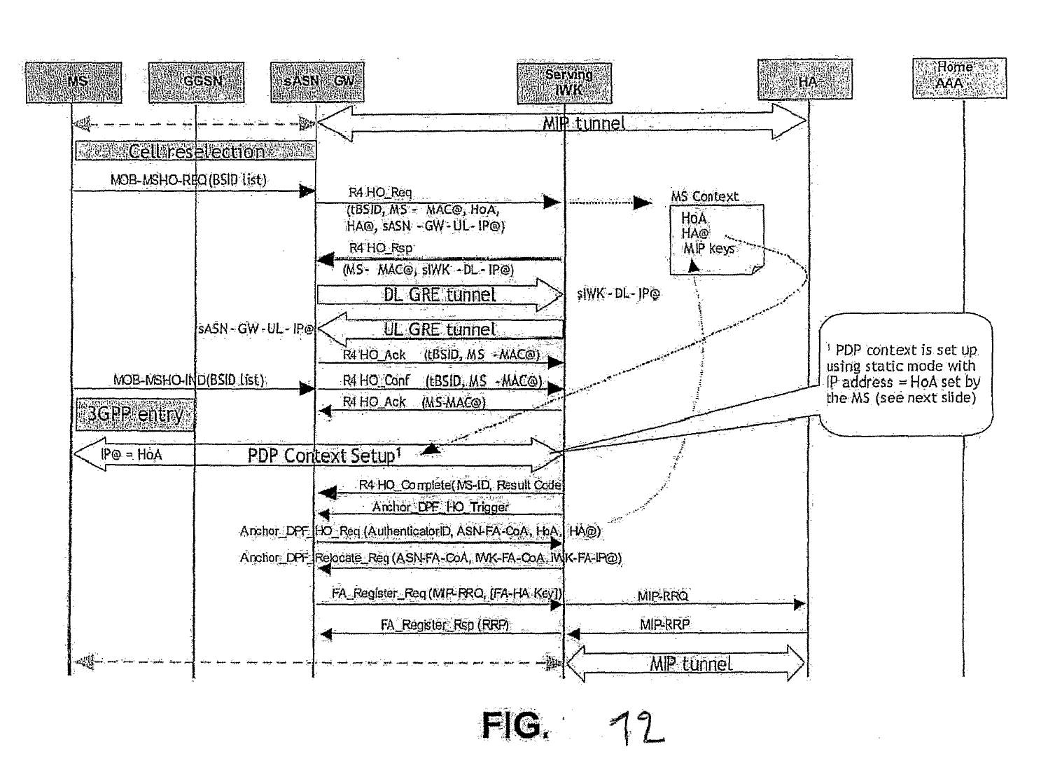

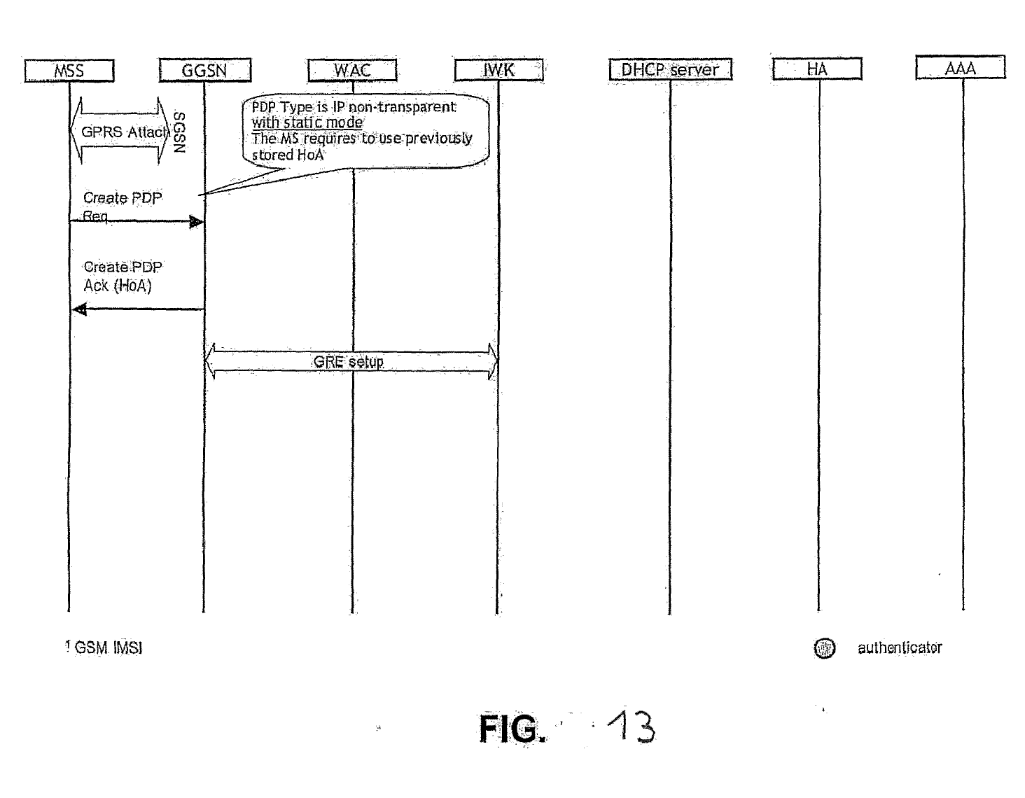

FIG. 13. depicts GSM-WiMAX inter-working, IP non-transparent PDP network re-entry (handover WiMAX to GSM)—Static mode, according to an embodiment of the present invention;

FIG. 14. depicts GSM-WiMAX inter-working, GSM→WiMAX HO, according to an embodiment of the present invention;

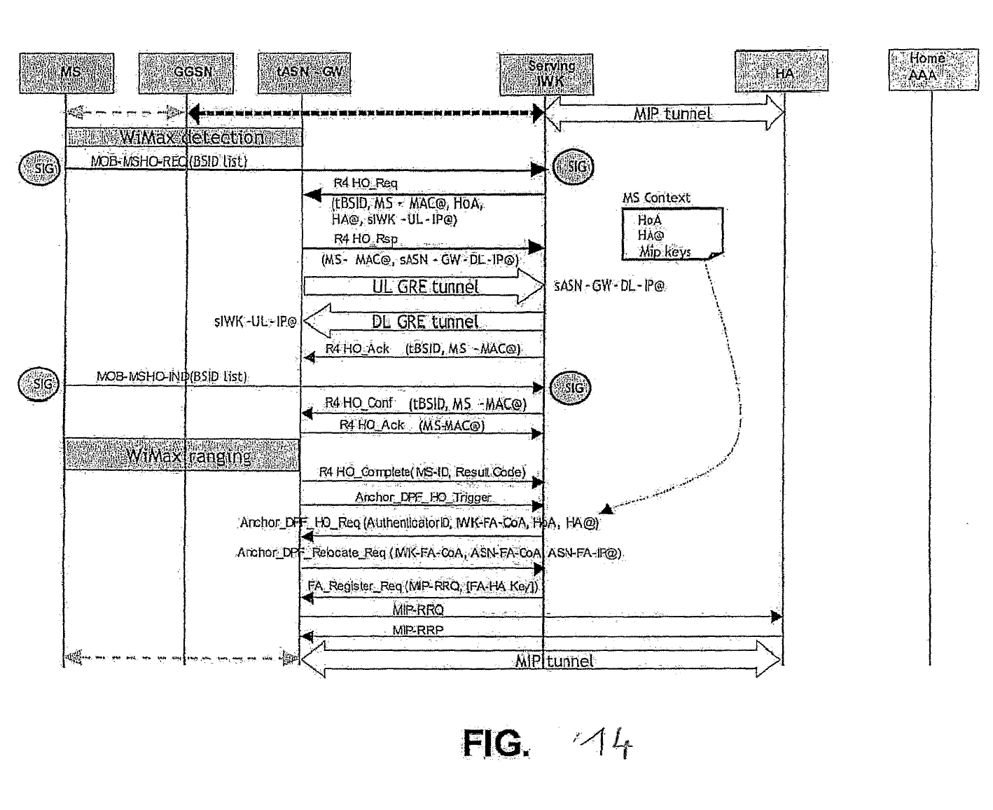

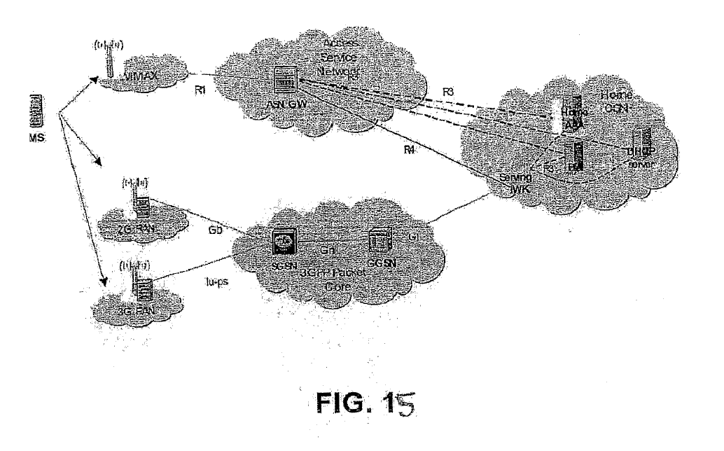

FIG. 15. depicts a 3GPP-WiMax optimized handover architecture according to an embodiment of the present invention;

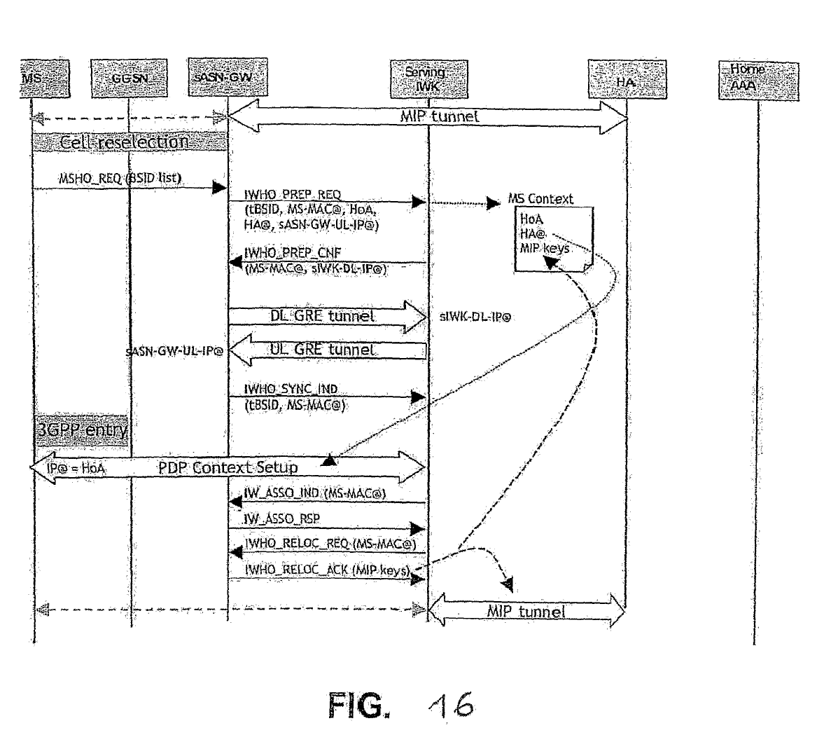

FIG. 16. is a flow diagram that depicts sequences and data for WiMax to 3GPP optimized handover, according to an embodiment of the present invention;

FIG. 17. is a flow diagram that depicts sequences and data for 3GPP to WiMax optimized handover, according to an embodiment of the present invention;

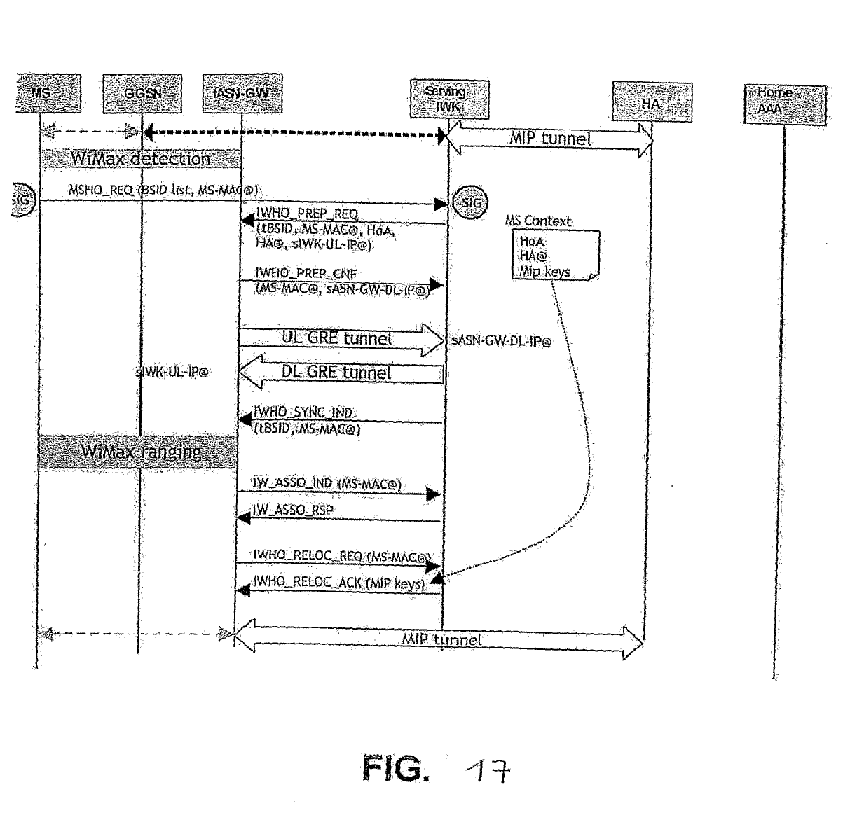

FIG. 18 depicts 3GPP and WiMax systems prior to a handover according to an embodiment of the present invention;

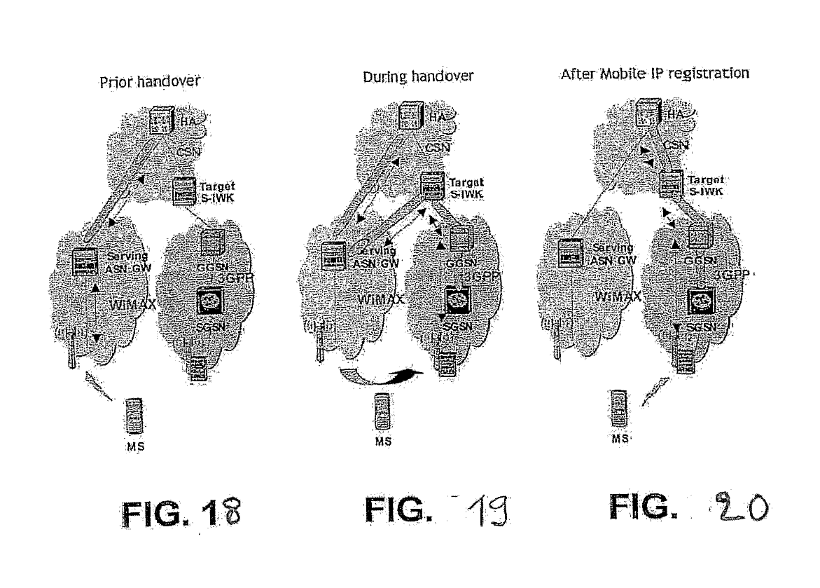

FIG. 19 depicts 3GPP and WiMax systems during handover according to an embodiment of the present invention;

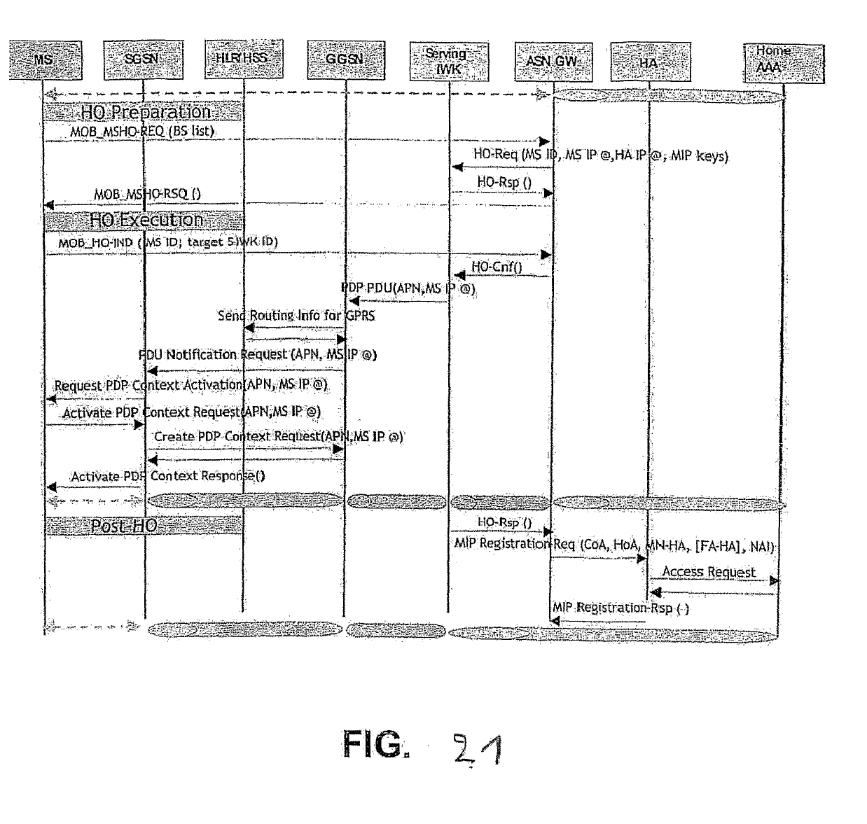

FIG. 20 depicts 3GPP and WiMax systems after mobile IP registration according to an embodiment of the present invention;

FIG. 21 is a flow diagram that depicts sequences and data regarding handover optimization according to an embodiment of the present invention;

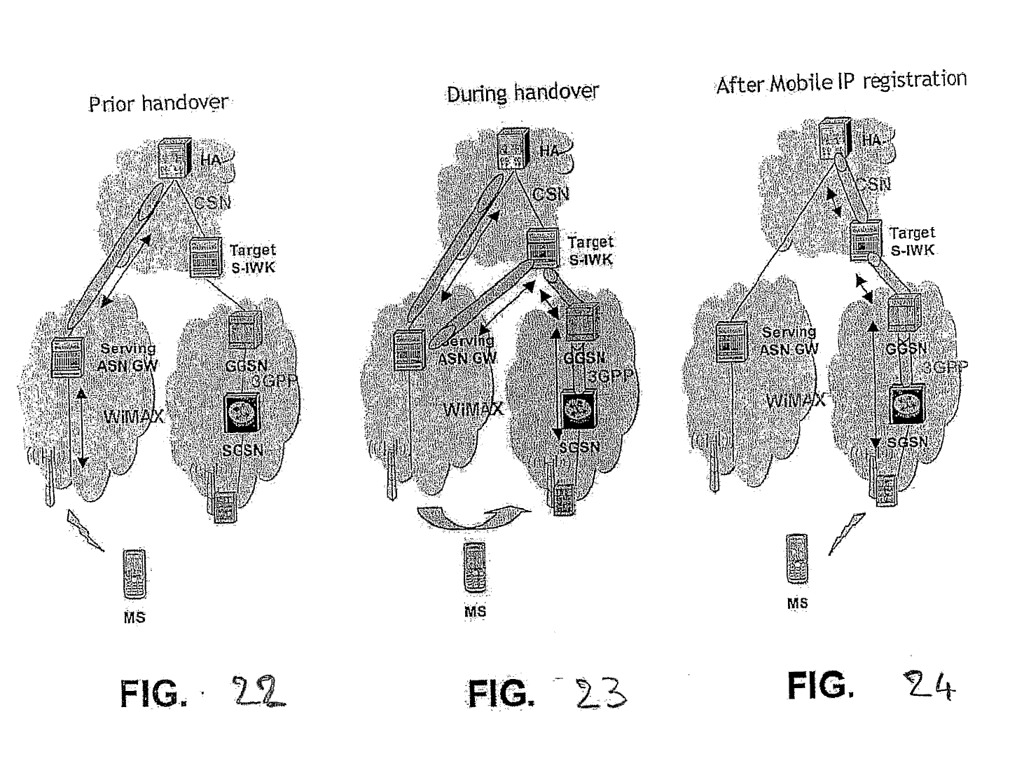

FIGS. 22-24 depict Loosely-Coupled Interworking—WiMAX/3GPP mobility, according to an embodiment of the present invention;

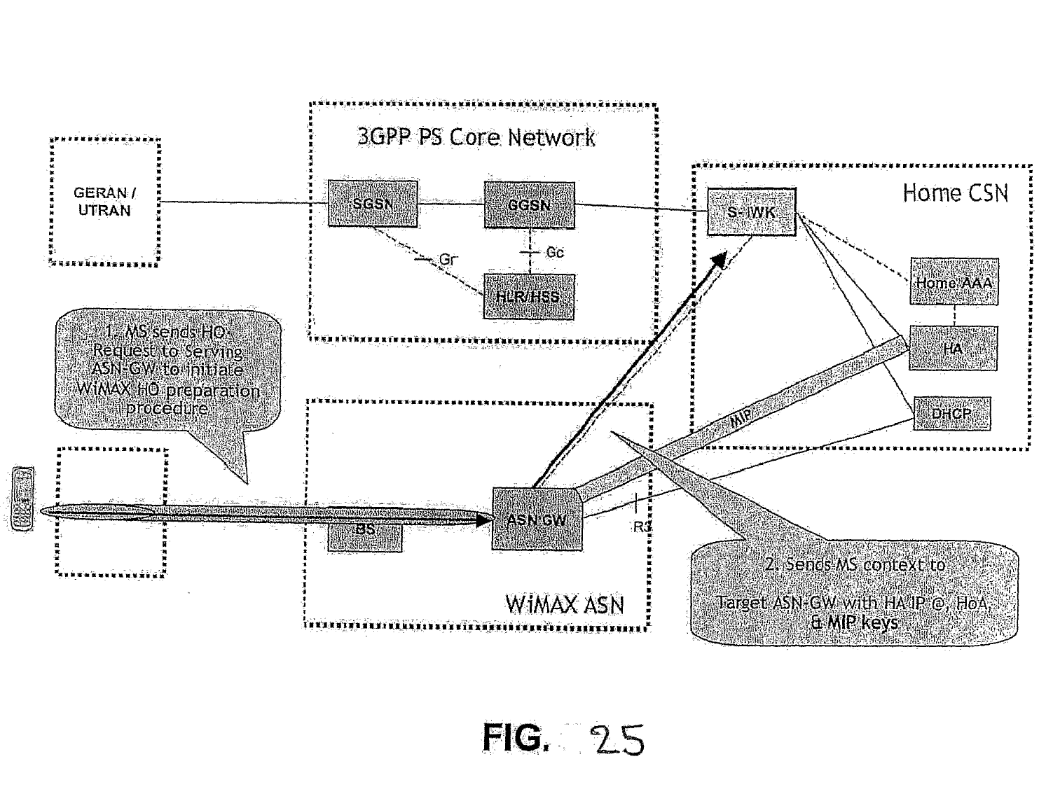

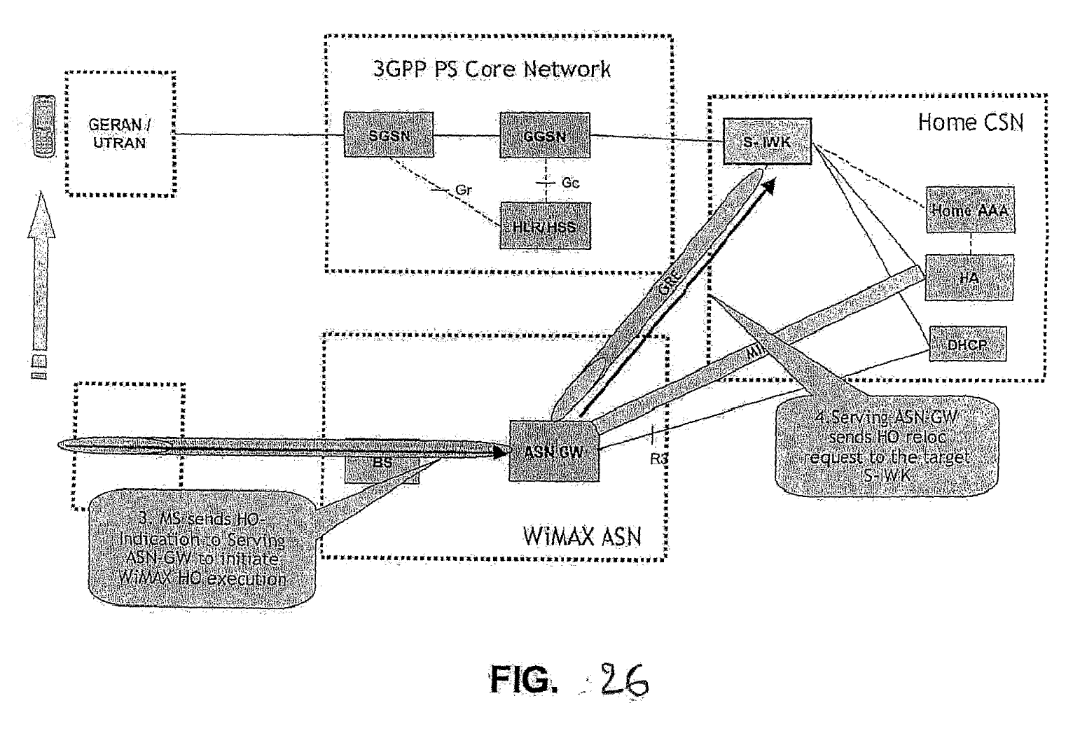

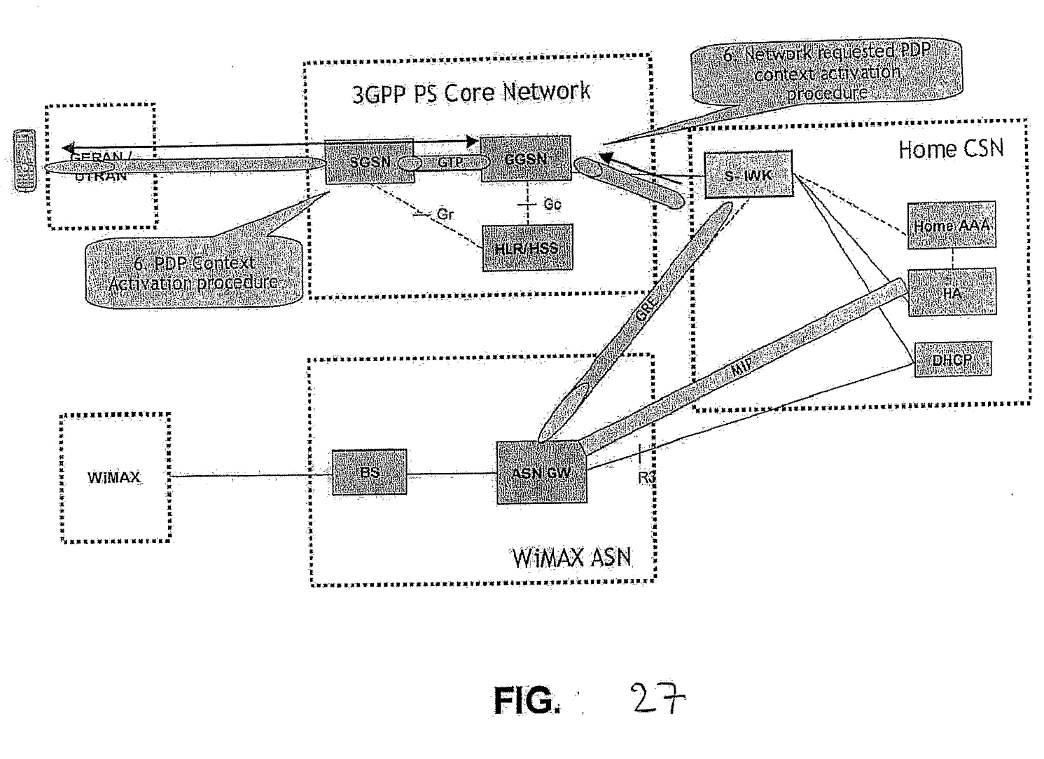

FIG. 25-28 depict R4 optimized handover from WiMAX to 3GPP, according to an embodiment of the present invention;

FIG. 29 depicts Handover WiMAX TO 3GPP, according to an embodiment of the present invention;

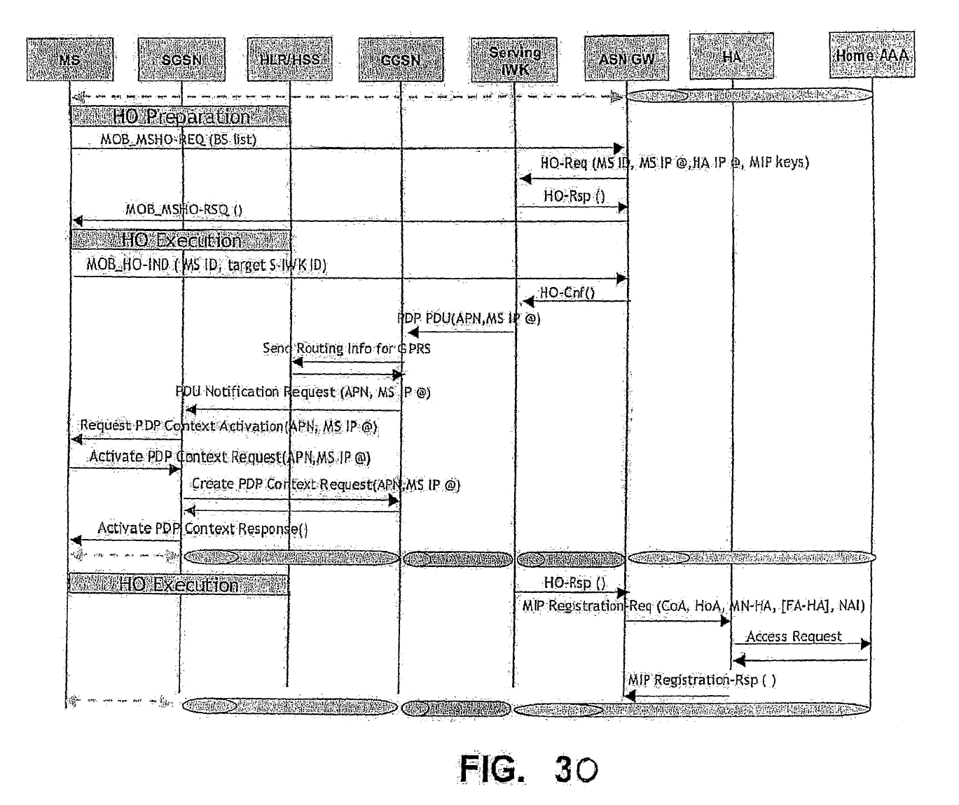

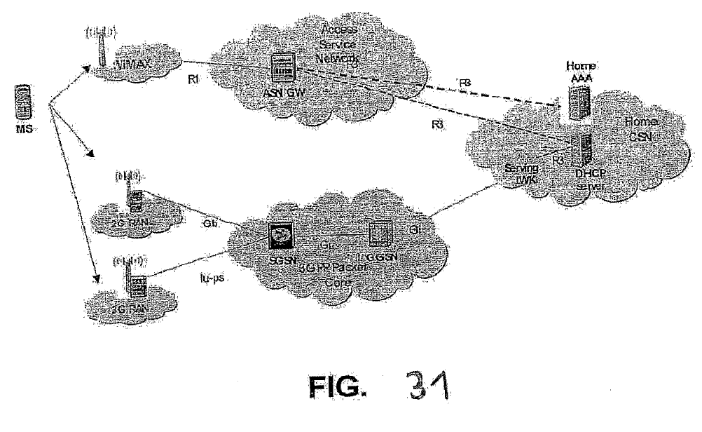

FIG. 30 depicts further Handover WiMAX TO 3GPP, according to an embodiment of the present invention.

FIG. 31 depicts 3GPP-WIMAX common IP address architecture according to an embodiment of the present invention;

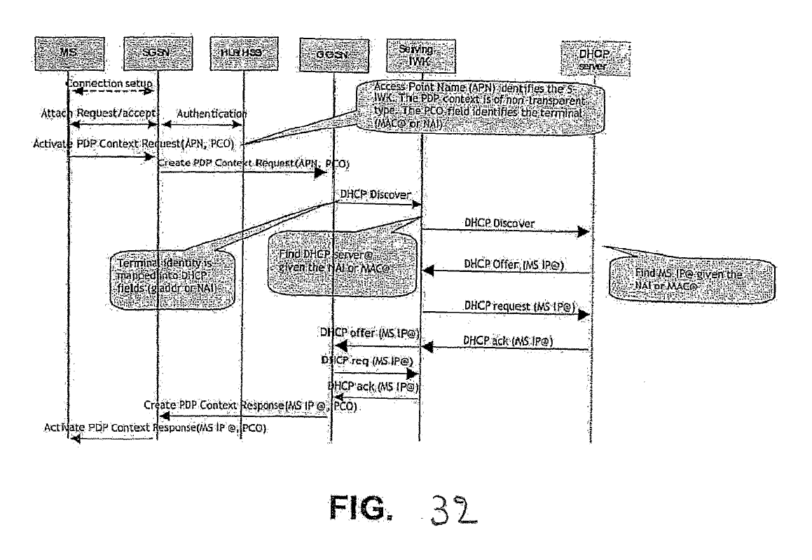

FIG. 32 is a flow diagram that depicts sequences and data for an address configuration mechanism from WiMax to 3GPP according to an embodiment of the present invention;

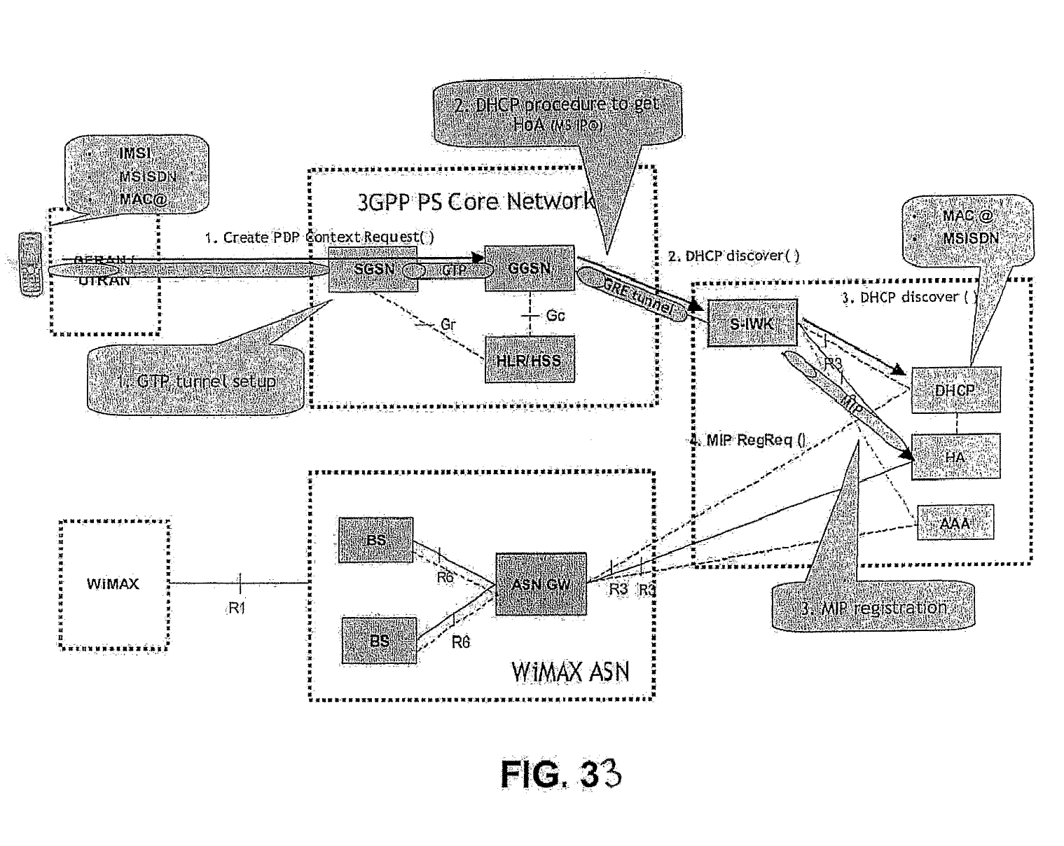

FIG. 33 depicts 3GPP Network entry scenario, according to an embodiment of the present invention;

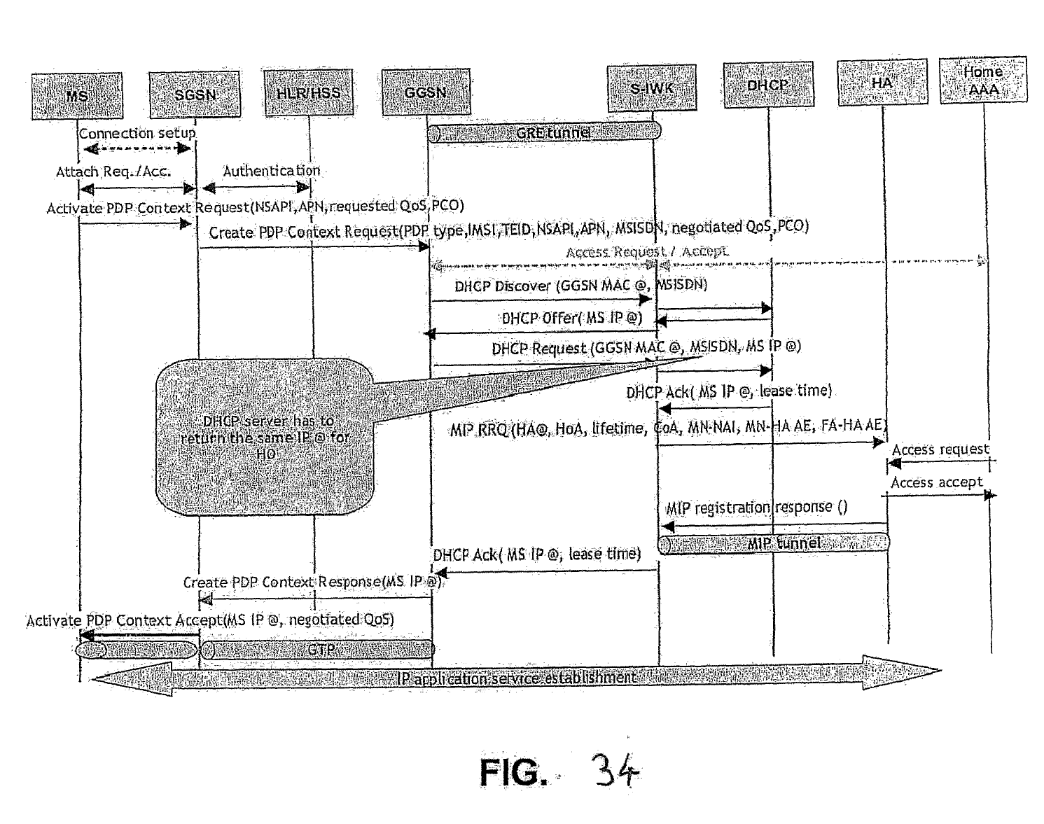

FIG. 34 depicts 3GPP network (re-)entry, according to an embodiment of the present invention;

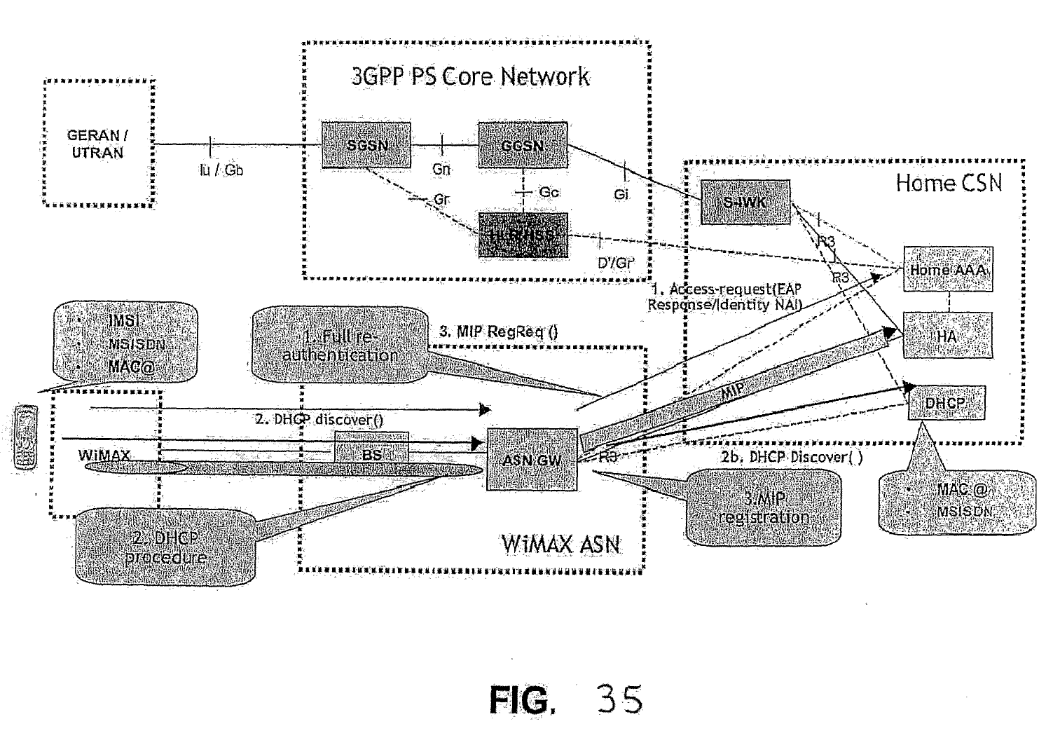

FIG. 35 depicts WiMAX Network entry, according to an embodiment of the present invention;

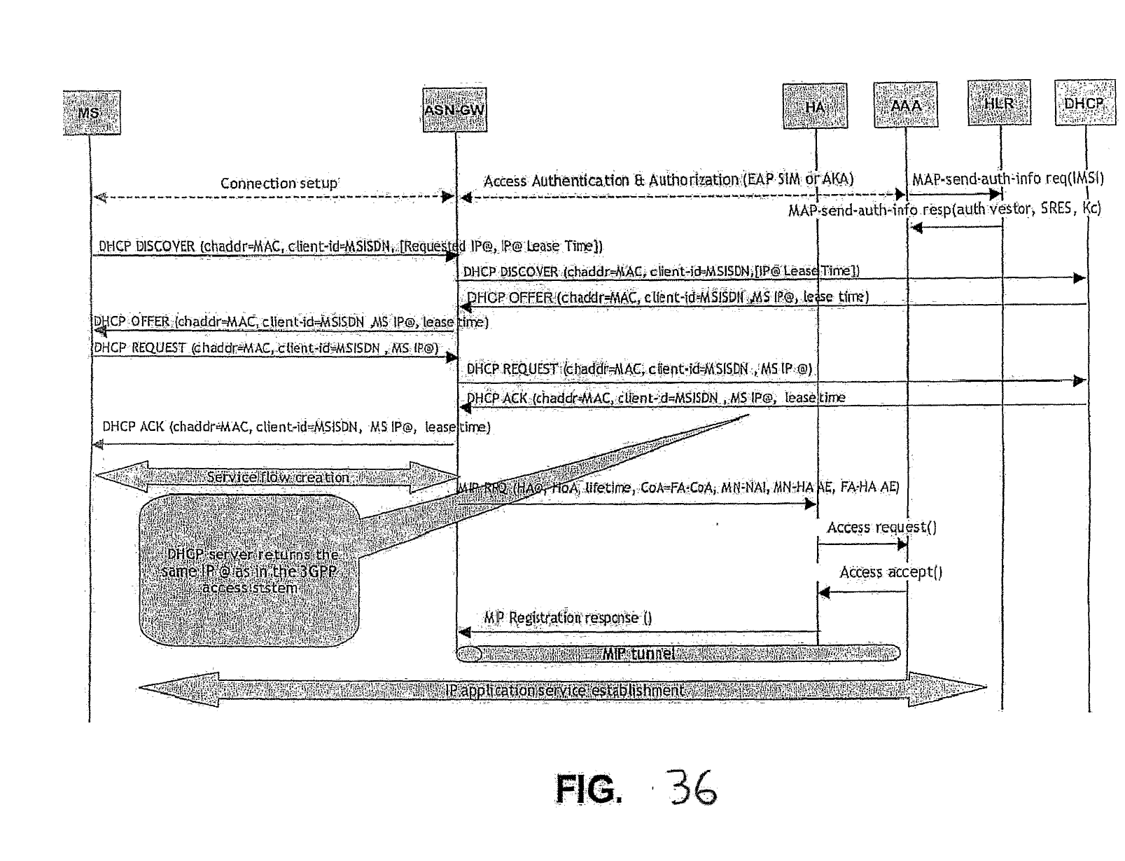

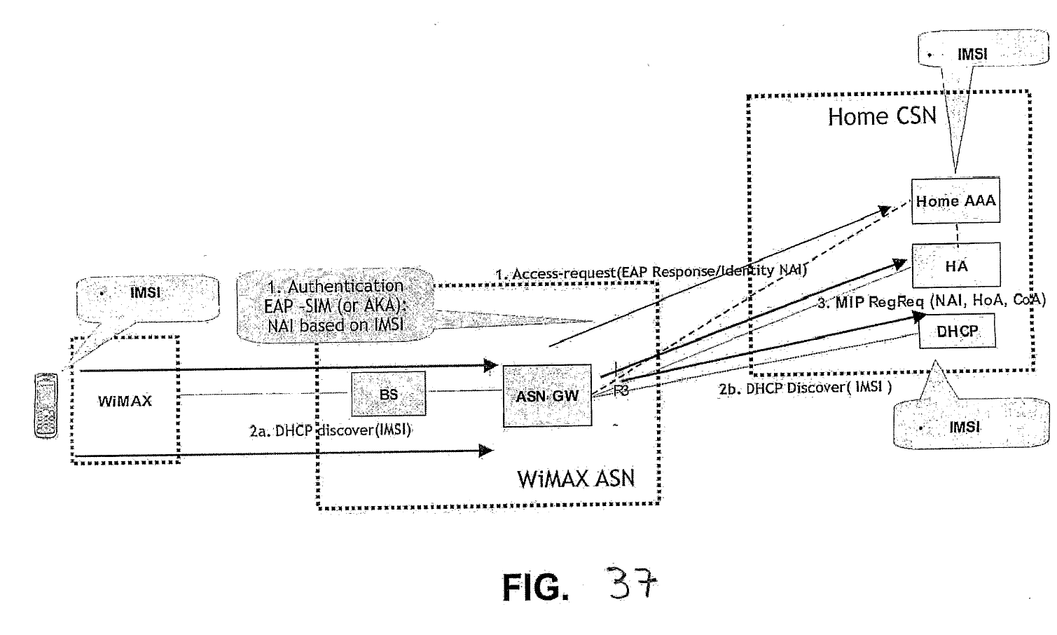

FIG. 36 depicts further WiMAX Network entry, according to an embodiment of the present invention.

FIG. 37 depicts a WiMax access network;

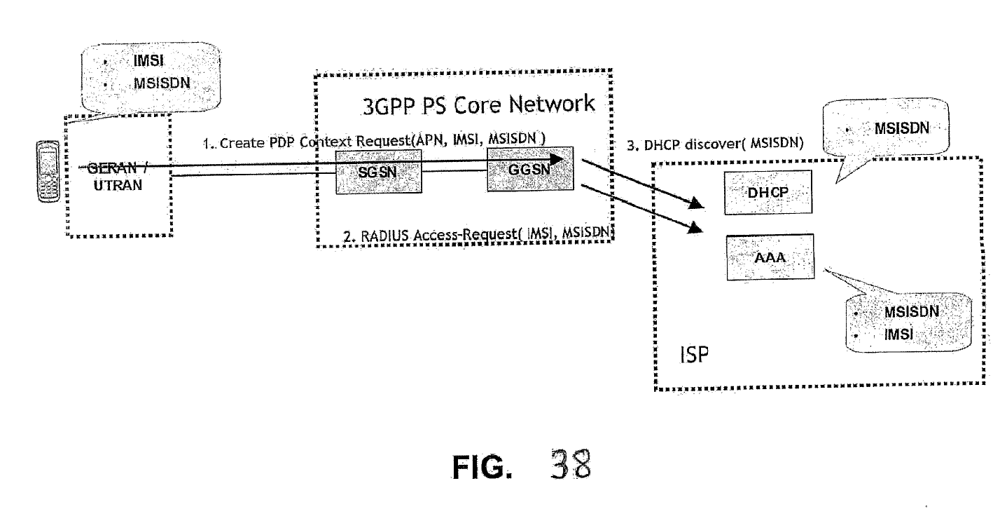

FIG. 38 depicts a 3GPP access network;

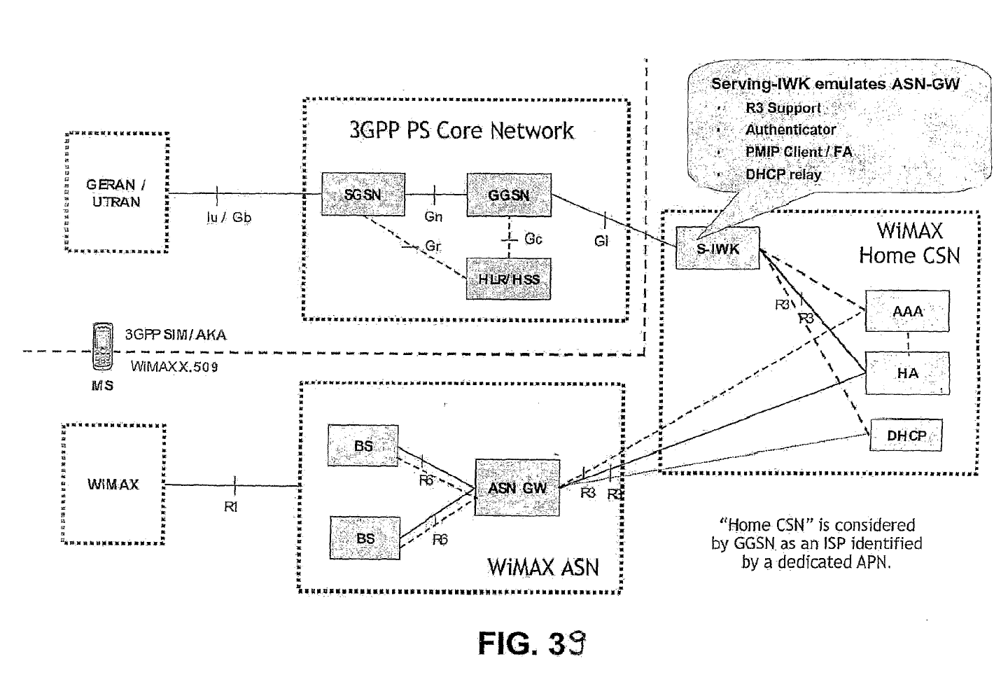

FIG. 39 depicts an inter-working architecture or model, according to an embodiment of the present invention for a WiMax network and a 3GPP network;

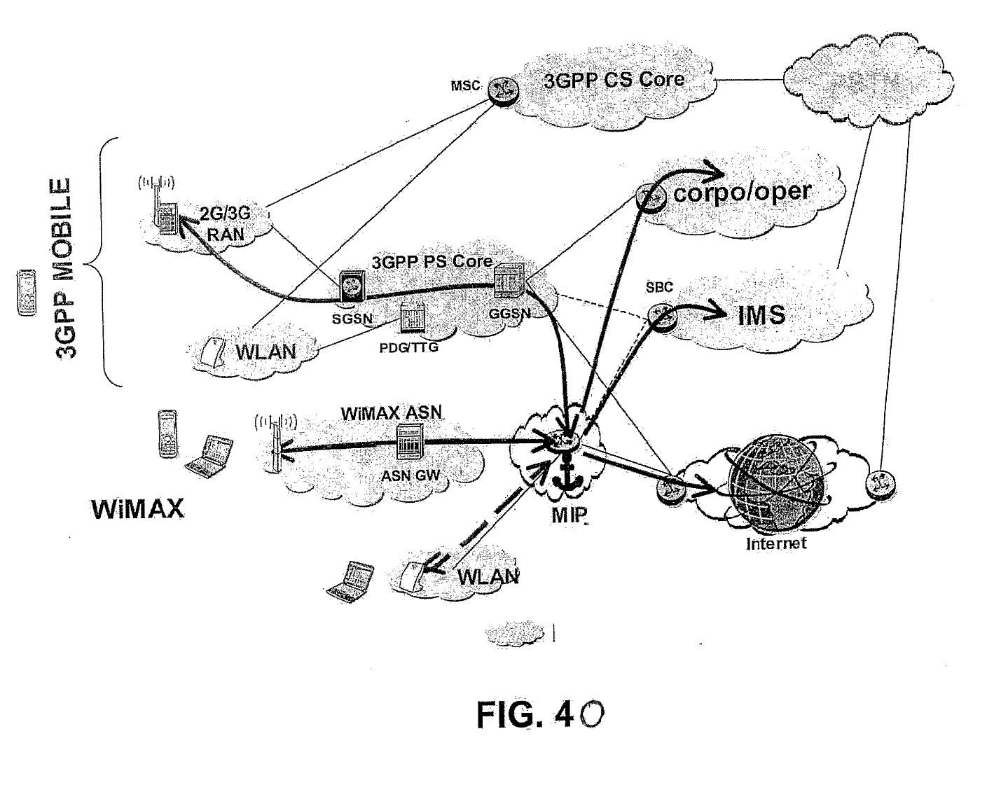

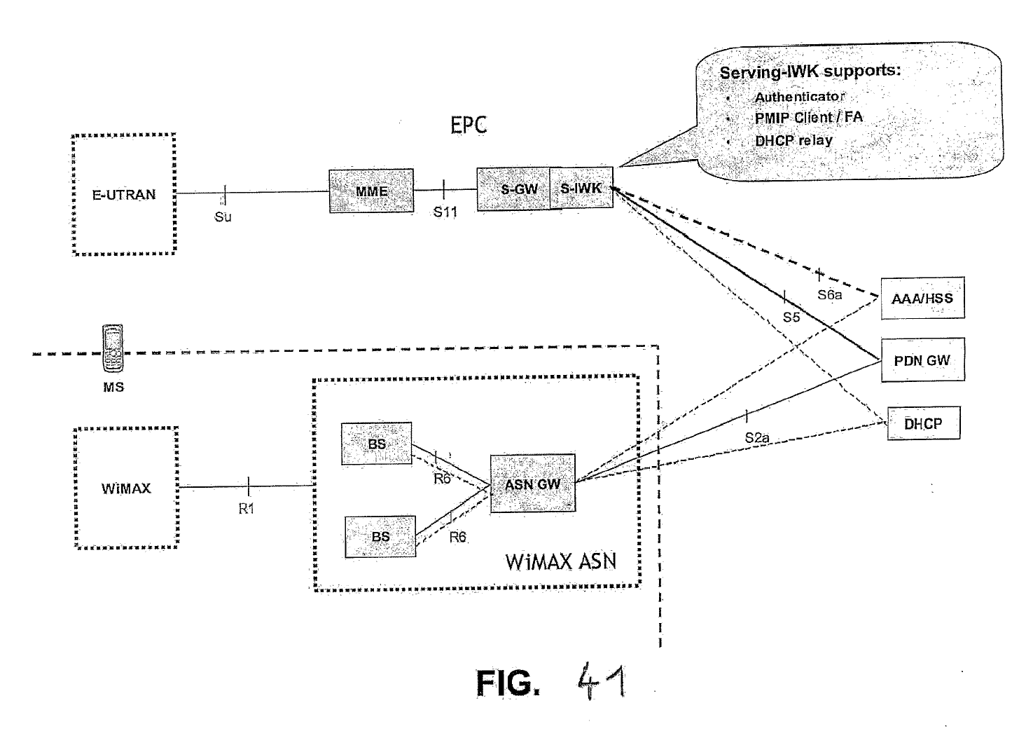

FIG. 40 depicts MIP-based inter-working function according to an embodiment of the present invention for a WiMax network and a 3GPP network;

FIG. 41 depicts an interworking model that is based on an SAE architecture, according to an embodiment of the present invention;

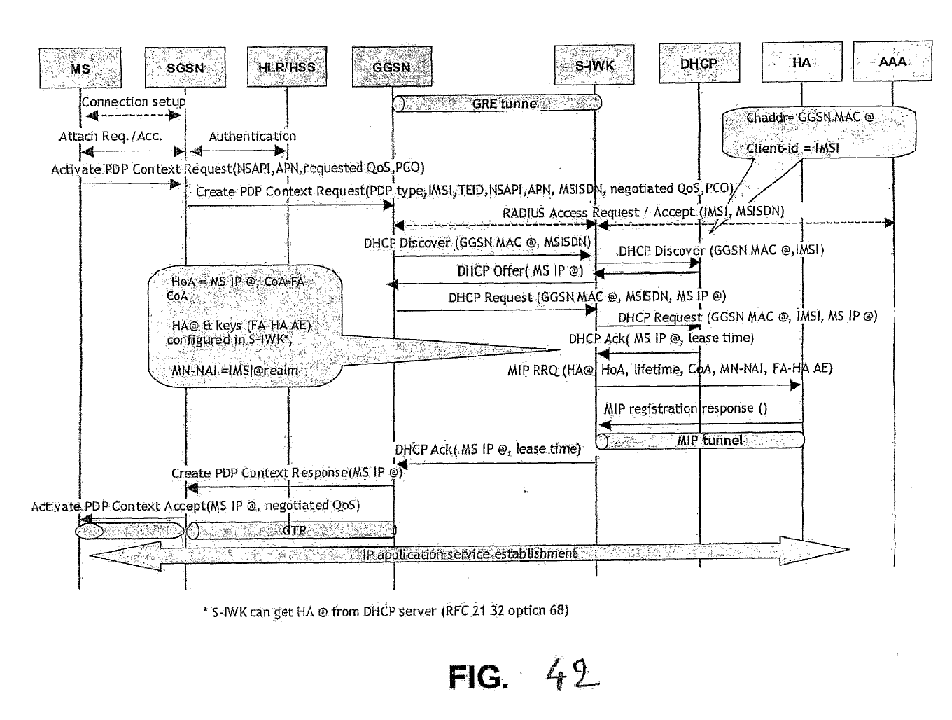

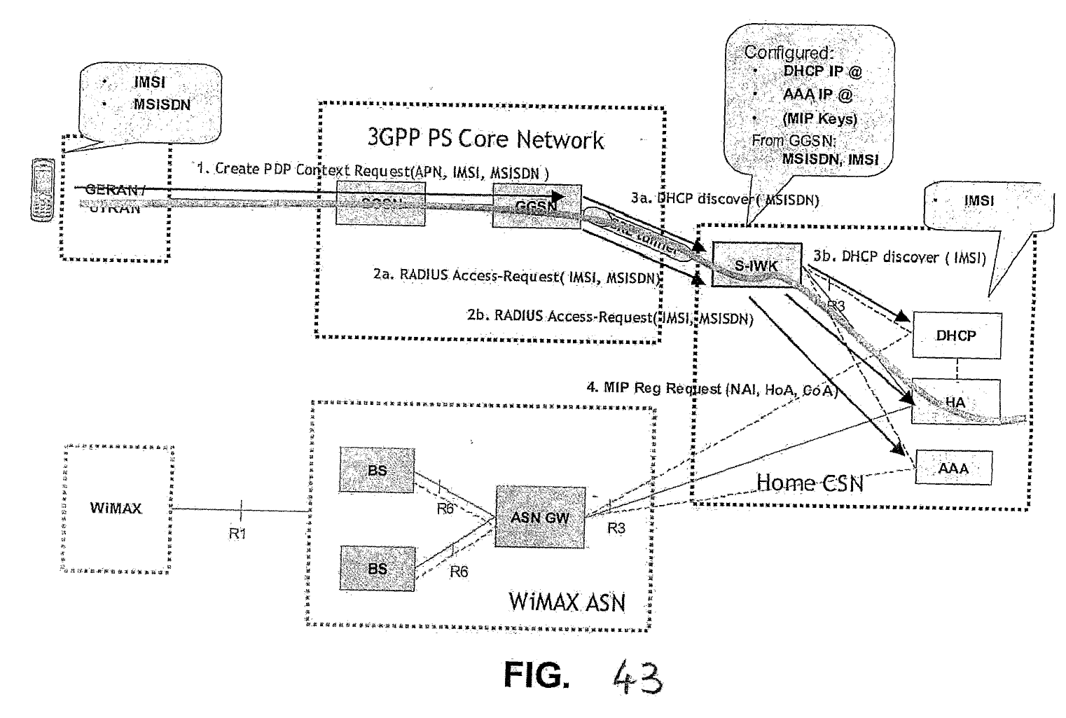

FIG. 42 depicts a flow diagram that depicts sequences and data for an embodiment of a (RE-)Entry 3GPP network procedure according to an embodiment of the present invention;

FIG. 43 depicts a 3GPP network entry scenario according to an embodiment of the present invention; and

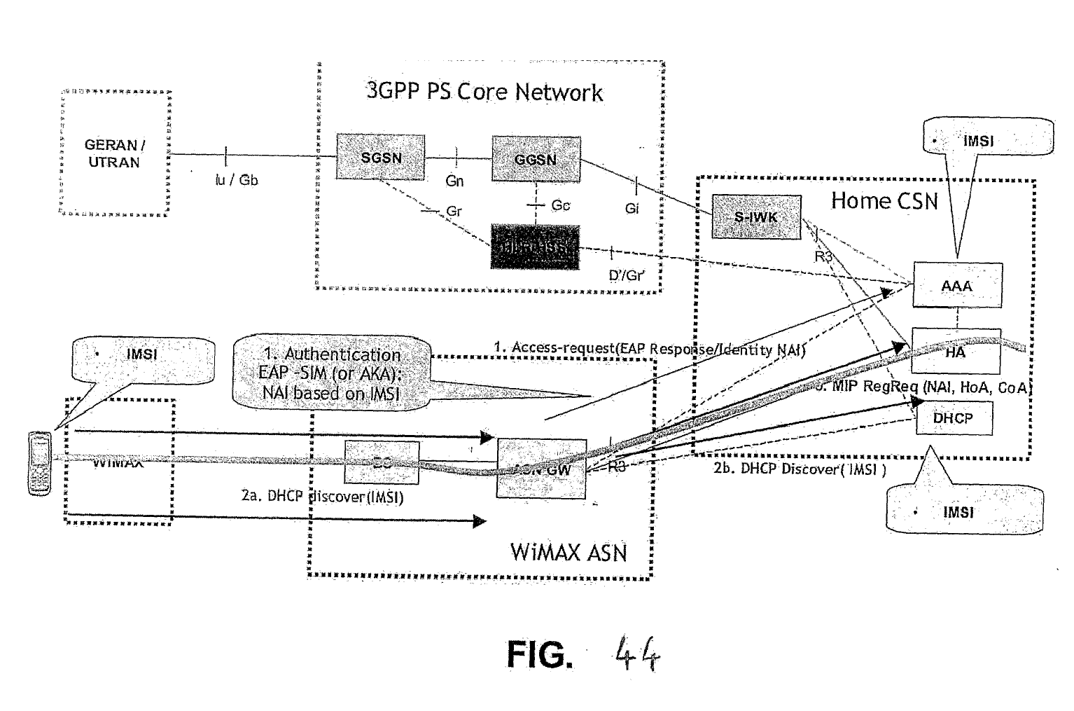

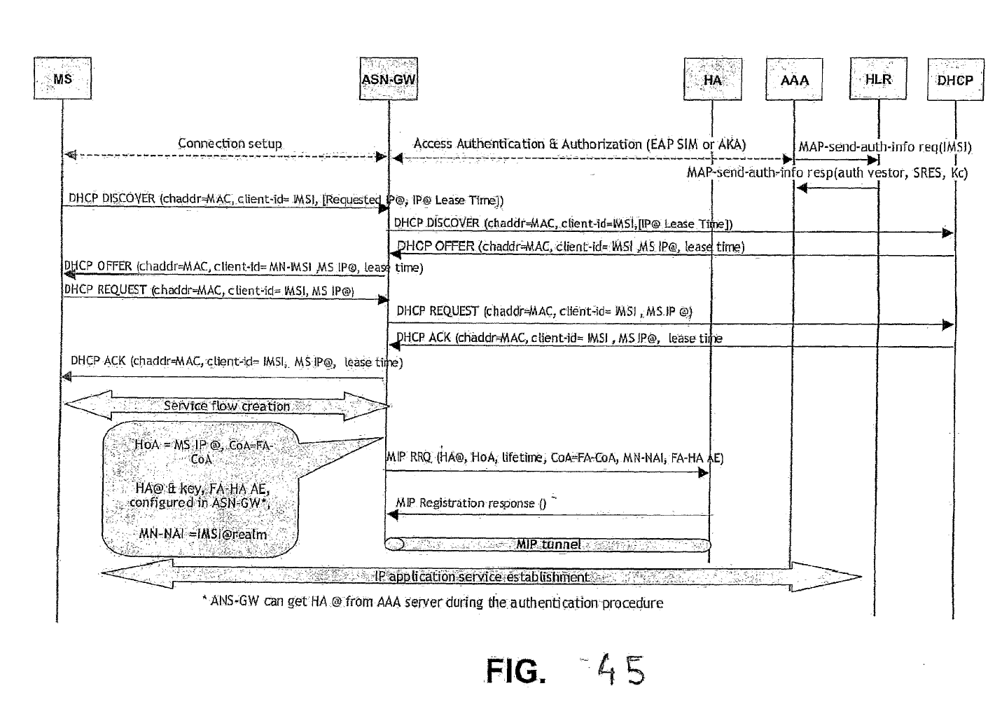

FIGS. 44 and 45 depict a WiMax network entry scenario according to an embodiment of the present invention.

In figures illustrating flow diagrams, a message containing certain information or parameters will also be illustrated by the name of this message followed by these information or parameters in parentheses.

FIG. 1 illustrates 3GPP-WiMAX inter-working architecture according to an embodiment of the present invention.

The architecture illustrated in FIG. 1 comprises:

a dual-mode WiMAX/3GPP Mobile Station MS (or UE),

a WiMAX network comprising ASN and Home CSN, ASN in turn comprising entities such as BS and ASN-GW, and Home CSN in turn comprising entities such as AAA Server, Home Agent HA and DHCP Server,

a 3GPP access network comprising RAN (such as GERAN/UTRAN) and PS Core Network, such as 2G/3G PS Core Network, in turn comprising entities such as SGSN, GGSN, HLR/HSS and 3GPP AAA Server.

A 3GPP/WiMAX interworking node (noted IWK) is introduced. IWK connects with the 3GPP Packet Core Network using 3GPP Gi interface, and with the WiMAX Connectivity Service Network CSN using WiMAX R3 interface. IWK interfaces with a GGSN in the 3GPP Packet Core Network using 3GPP Gi interface. In the illustrated embodiment, IWK comprises a Foreign Agent FA.

FIG. 2 illustrates 3GPP-WiMAX inter-working, PPP PDP Context architecture, according to an embodiment of the present invention. The architecture illustrated in FIG. 2 comprises GTP tunnel between GERAN/UTRAN and GGSN, L2TP tunnel between GGSN and Serving IWK, and PPP tunneled between GERAN/UTRAN and Serving IWK.

FIG. 3 illustrates 3GPP-WiMAX inter-working, PPP PDP network entry (HoA obtained from DHCPs in WiMAX), according to an embodiment of the present invention;

The following steps are illustrated in FIG. 3.

GPRS Attach is performed between MS and SGSN.

PDP context Setup is performed between MS and GGSN (PDP type is PPP. APN maps to IWK@ with L2TP. Authentication might apply). This might rely on IPSec tunnel. Done once for first PDP context created towards a given IWK.

PPP-LCP configuration exchanges are performed between MS and IWK.

PPP-EAP authentication exchanges are performed between MS and IWK.

EAP authentication exchanges (WiMAX) are performed between IWK and AAA Server. MS context information (HA@, DHCPs@, outer NAI, MN-HA key, [FA-HA key], MAC@) are provided to IWK.

MS sends PPP-IPCP Conf-Req (IP Address ?) to IWK.

IWK sends DHCP Discover (MAC@).

DHCP Server sends DHCP offer (HoA) to IWK.

IWK sends DHCP req (HoA) to DHCP server.

DHCP Server sends DHCP ack (HoA) to IWK.

IWK sends MIP RegReq (CoA, HoA, MN-HA, [FA-HA], NAI) to HA.

HA sends Access Request to AAA Server.

AAA Server sends Access Accept to HA.

HA sends MIP RegRep (CoA, HoA, MN-HA, [FA-HA], NAI) to IWK.

IWK sends PPP-IPCP Conf-Ack (IP Address=HoA) to MS.

FIG. 4. illustrates 3GPP-WiMAX inter-working, PPP PDP network entry (HoA pushed from DHCPs in WiMAX), according to an embodiment of the present invention;

The following steps are illustrated in FIG. 4.

GPRS Attach is performed between MS and SGSN.

PDP context Setup is performed between MS and GGSN (PDP type is PPP. APN maps to IWK@ with L2TP. Authentication might apply). This might rely on IPSec tunnel. Done once for first PDP context created towards a given IWK.

L2TP setup between GGSN and IWK.

PPP-LCP configuration exchanges are performed between MS and IWK.

PPP-EAP authentication exchanges are performed between MS and IWK.

EAP authentication exchanges (WiMAX) are performed between IWK and AAA Server. MS context information (HA@, DHCPs@, outer NAI, MN-HA key, [FA-HA key], MAC@) are provided to IWK.

IWK sends DHCP Discover (MAC@).

DHCP Server sends DHCP offer (HoA) to IWK.

IWK sends DHCP req (HoA) to DHCP server.

DHCP Server sends DHCP ack (HoA) to IWK.

IWK sends PPP-IPCP Conf-Req (IP Address=HoA) to MS.

MS sends PPP-IPCP Conf-Ack (IP Address=HoA) to IWK.

IWK sends MIP RegReq (CoA, HoA, MN-HA, [FA-HA], NAI) to HA.

HA sends Access Request to AAA Server.

AAA Server sends Access Accept to HA.

HA sends MIP RegRep (CoA, HoA, MN-HA, [FA-HA], NAI) to IWK.

FIG. 5. illustrates 3GPP-WiMAX inter-working, PPP PDP network entry (PPP-LCP configuration exchanges), according to an embodiment of the present invention;

The following steps are illustrated in FIG. 5.

MS sends PPP-LCP Conf-Req to IWK. Conf-Req should be issued and acknowledged by both PPP ends although it may happen in any order (MS first or IWK first). Con-Req must negotiate the usage of EAP authentication.

IWK sends PPP-LCP Conf-Ack to MS.

IWK sends PPP-LCP Conf-Req to MS.

MS sends PPP-LCP Conf-Ack to IWK.

FIG. 6. illustrates 3GPP-WiMAX inter-working, PPP PDP network entry (PPP-EAP authentication exchanges (Single user EAP-SIM authentication is detailed)), according to an embodiment of the present invention;

The following steps are illustrated in FIG. 6.

IWK sends PPP-EAP Request Identity to MS.

MS sends PPP-EAP Response Identity to IWK.

IWK sends EAP Response Identity to AAA.

AAA sends EAP Request Challenge to IWK.

IWK sends PPP-EAP Request Challenge to MS.

MS sends PPP-EAP Response Challenge to IWK.

IWK sends EAP Response Challenge to AAA.

AAA sends EAP Request Notification (Success) to IWK.

IWK sends PPP-EAP Request Notification (Success) to MS.

MS sends PPP-EAP Response Notification (Success) to IWK.

IWK sends EAP Response Notification (Success) to AAA.

FIG. 7. illustrates 3GPP-WiMAX inter-working, IP non-transparent PDP Context architecture, according to an embodiment of the present invention. The architecture illustrated in FIG. 2 comprises GTP tunnel between GERAN/UTRAN and GGSN, GRE tunnel between GGSN and Serving IWK, and IP tunneled between GERAN/UTRAN and Serving IWK.

FIG. 8. illustrates 3GPP-WiMAX inter-working, IP non-transparent PDP network entry (IMSI⇄MAC@ mapping), according to an embodiment of the present invention.

The following steps are illustrated in FIG. 8:

GPRS Attach is performed between MS and SGSN.

MS sends Create PDP Req. PDP type is IP non-transparent. APN maps to IWK@. Authentication might apply.

GGSN sends DHCP Discover (IMSI).

IWK maps GSM IMSI to WiMAX MAC @, and locates DHCPs for MAC@.

IWK acting as a DHCP relay sends DHCP Discover (MAC@).

DHCP Server sends DHCP offer (HoA) to IWK.

IWK sends DHCP offer (HoA) to GGSN.

GGSN sends DHCP req (HoA) to IWK.

IWK sends DHCP req (HoA) to DHCP Server.

DHCP Server sends DHCP ack (HoA) to IWK.

IWK sends DHCP ack (HoA) to GGSN.

GGSN sends Create PDP Ack (HoA) to MS. The IP@ (HoA) is stored at MS

GRE is setup between GGSN and IWK.

EAP authentication exchanges (WiMAX) are performed between MS and IWK. WiMAX authentication takes place over IP connection.

EAP authentication exchanges (WiMAX) are performed between IWK and AAA Server.

WiMAX Handover (HO) comprises: HO preparation, HO execution, HO post-execution.

HO preparation is recalled in FIG. 9.

The following steps are illustrated in FIG. 9:

MS sends MOB-MSHO-REQ (Target BS Info) to Serving BS.

Serving BS sends R6 HO-REQ (MS ID, [SBC PKM & REG Contexts], [SF Info], [sBS Info], Target BS Info (BSID)) to Serving ASN-GW.

Serving ASN GW selects a list of Candidate BS.

Serving ASN GW sends R4 HO_Req (HO Type, MS ID, [Anchor MM Context {Mobility Mode, HA@, HoA, CoA, MIP keys+SPIs}], [SBC, PKM & REG Contexts], Data Path Info, SF Info, Target BS Info, AK Context) to Target ASN-GW.

Target ASN GW sends R6 HO Req (HO Type, MS ID, AK Context, [SBC, PKM & REG Contexts], SF Info (QoS), Data Path Info) to Target BS.

Target BS sends R6 HO Rsp (HO Type, Result Code, MS ID, SF Info {SFID, Result Code, QoS}, BSID, [HO Process Optimization]) to Target ASN-GW.

Target ASN-GW sends R4 HO Rsp (HO Type, Result Code, MS ID, SF Info {SFID, Result Code, QoS}, BSID, [HO Process Optimization]) to Serving ASN GW. The exchange R4 HO Req, R4 HO Rsp include Data Path Pre-reg & Context Retrieval procedures.

Serving ASN GW decides to recommend BSs for the HO.

Serving ASN GW sends R6 HO Rsp (HO Operation Mode, MS ID, Target BS Info (BSID, HO Process Optimization) to Serving BS.

Serving BS sends MOB-BSHO-RSP (HO Mode, HO Operation Mode, Target BS Info (BSID, HO Process Optimization) to MS.

HO execution is recalled in FIG. 10.

The following steps are illustrated in FIG. 10:

MS sends MOB-HO-IND (HO Mode, Target_BS ID, Ranging Params valid indication) to Serving BS.

Serving BS sends R6 HO-Cnf (HO Confirm Type, MS ID, Target BS Info) to Serving ASN GW.

Serving ASN GW sends R4-HO-Cnf (MS ID, Target BS Info) to Target ASN GW.

Target ASN GW sends R6 HO Cnf (MS ID, Anchor GW ID, Target BS Info, HO Confirm) to Target BS.

Target BS sends R6 HO Ack (MS-ID) to Target ASN GW.

Target ASN GW sends R4 HO Ack (MS-ID) to Serving ASN GW.

Serving ASN GW sends R6 HO Ack (MS-ID) to Serving BS.

MS Network Re-entry is performed, including Ranging, Negotiate basic capabilities, PKM Authentication phase, TEK establishment phase, Registration).

Target BS sends R6 Path_Reg_Req (MS-ID) to Target ASN GW.

Target ASN GW sends R4 Path_Reg_Req (MS-ID) to Serving ASN GW.

Serving ASN GW sends R4 Path_Reg_Rsp (MS-ID) to Target ASN GW.

Target ASN GW sends R6 Path_Reg_Rsp (MS-ID) to Target BS.

Completion of network entry is performed at Target BS.

Target BS sends R6 CMAC_Key_Count_Update to Target ASN GW.

Target ASN GW sends R4 CMAC_Key_Count_Update to Serving ASN GW.

Serving ASN GW sends R4 CMAC_Key_Count_Update_Ack to Target ASN GW.

Target ASN GW sends R6 CMAC_Key_Count_Update_Ack to Target BS.

Target BS sends R6 HO Complete (MS-ID, Result Code) to Target ASN GW.

Target ASN GW sends R4 HO Complete (MS-ID, Result Code) to Serving ASN GW.

Serving ASN GW sends R6 HO Complete (MS-ID, Result Code) to Serving BS.

HO post-execution is recalled in FIG. 11.

The following steps are illustrated in FIG. 11:

DPF 2 (DPF Function in New Serving (ex-Target) ASN GW) sends Anchor_DPF_HO_Trigger to DPF1 (DPF Function in Anchor (ex-serving) ASN GW).

DPF1 sends Anchor_DPF_HO_Req (Authenticator ID, FA1-CoA, Anchor MM Context {HoA, HA@}) to DPF2.

Exchanges between DPF2 and FA2 (Foreign Agent in New serving (ex-Target) ASN GW).

DPF2 sends Anchor DPF_Relocate_Req (FA1-CoA, FA2-CoA, FA2-IP@) to PMP Client in Anchor (ex-Serving) ASN GW.

Exchanges between PMIP Client and Authenticator (FA-HA key+SPI)

PMIP Client sends FA_Register_Req (MIP-RRQ, [FA-HA]Key]) to FA2.

FA2 sends MIP-RRQ to HA.

HA sends MIP-RRP to FA2.

FA2 sends FA_Register_Rsp (RRP) to PMIP Client.

FIG. 12. illustrates 3GPP-WiMAX inter-working, WiMAX→GSM HO, according to an embodiment of the present invention;

The following steps are illustrated in FIG. 12:

A MIP Tunnel is established between serving ASN GW and HA.

Cell reselection is performed for the MS.

MS sends MOB-MSHO-REQ (BSID list) to ASN GW.

ASN GW sends R4 HO Req (TBSID, MS-MAC@, HoA, HA@, sASN-GW-UL-IP@) to Serving IWK.MS Context (HoA, HA@, MIP keys) is stored at IWK.

IWK sends R4 HO Rsp (MS-MAC@, sIWK-DL-IP@) to ASN GW.

DL (Downlink) and UL (Uplink) GRE tunnels are established between ASN GW and IWK.

ASN GW sends R4 HO Ack (tBSID, MS-MAC@) to IWK.

MS sends MOB-MSHO-IND (BSID list) to ASN GW.

ASN GW sends R4 HO Conf (tBSID, MS-MAC@) to IWK.

IWK sends R4 HO Ack (MS-MAC@) to ASN GW.

3GPP entry is performed.

PDP Context is setup between MS and IWK (PDP context is setup using static mode with IP address=HoA set by the MS (see FIG. 13).

IWK sends R4 HO Complete (MS-ID, Result Code) to ASN GW.

IWK sends Anchor_DPF_HO_Trigger to ASN GW.

ASN GW sends Anchor_DPF_HO_Req (Authenticator ID, ASN-FA-CoA, HoA, HA@) to IWK.

IWK sends Anchor_DPF_Relocate_Req (ASN-FA-CoA, IWK-FA-CoA, IWK-FA-IP@) to ASN GW.

ASN GW sends FA-Register_Req (MIP-RRQ, [FA-HA Key]) to IWK.

IWK sends MIP-RRQ to HA.

HA sends MIP-RRP to IWK.

IWK sends FA_Register_Rsp (RRP) to ASN GW

MIP tunnel is established between IWK and HA.

FIG. 13. 3GPP-WiMAX inter-working, IP non-transparent PDP network re-entry (handover WiMAX to GSM)—Static mode, according to an embodiment of the present invention;

The following steps are illustrated in FIG. 13:

GPRS Attach is performed between MS and SGSN.

MS sends Create PDP Req. PDP type is IP non-transparent with static mode. The MS requires to use previously stored HoA.

GGSN sends Create PDP Ack (HoA).

GRE tunnel is established between GGSN and IWK.

FIG. 14. illustrates 3GPP-WiMAX inter-working, GSM→WiMAX HO, according to an embodiment of the present invention.

The following steps are illustrated in FIG. 14.

A MIP Tunnel is established between serving IWK and HA.

WiMAX detection is performed for the MS.

MS sends MOB-MSHO-REQ (BSID list) to serving IWK.

IWK sends R4 HO Req (TBSID, MS-MAC@, HoA, HA@, sIWK-UL-IP@) to target ASN GW.

ASN GW sends R4 HO Rsp (MS-MAC@, sASN-GW-DL-IP@) to IWK.

DL (Downlink) and UL (Uplink) GRE tunnels are established between ASN GW and IWK.

IWK sends R4 HO Ack (tBSID, MS-MAC@) to ASN GW.

MS sends MOB-MSHO-IND (BSID list) to IWK.

IWK sends R4 HO Conf (tBSID, MS-MAC@) to ASN GW.

ASN GW sends R4 HO Ack (MS-MAC@) to IWK.

WiMAX ranging is performed.

ASN GW sends R4 HO Complete (MS-ID, Result Code) to IWK.

ASN GW sends Anchor_DPF_HO_Trigger to IWK.

IWK sends Anchor_DPF_HO_Req (Authenticator ID, IWK-FA-CoA, HoA, HA@) to ASN GW.

ASN GW sends Anchor_DPF_Relocate_Req (IWK-FA-CoA, ASN-FA-CoA, ASN-FA-IP@) to IWK.

IWK sends FA-Register_Req (MIP-RRQ, [FA-HA Key]) to ASN GW.

ASN GW sends MIP-RRQ to HA.

HA sends MIP-RRP to ASN GW.

MIP tunnel is established between ASN GW and HA.

The following sets forth some of the features of the systems depicted in FIGS. 1-14.

Regarding the GSM-WiMAX inter-working WiMAX Service Flows (State of the Art):

Low bit rate BE (Best Efforts) service flows are created and activated during network entry;

Other service flows are provisioned at AAA level. They are provided to ASN-GW during authentication. These service flows are created and activated during network entry. They are also transferred to (target ASN-GW, target BS) during HO preparation;

Service flows transfers might fail (i.e. during HO because the target BS cannot satisfy them) but Low bit rate BE is always created and activated; and

Currently ALU ASN-GW (WAC) supports only network-initiated service flow creation/activation (no support for MS-initiated SF creation/activation/deletion).

Regarding the GSM-WiMAX inter-working WiMAX Service Flows, GSM entry first (no WiMAX entry yet):

MS performs GSM network entry;

MS performs WiMAX authentication over GSM network;

S-IWK acts as authenticator for MS and gets back SF's provisioned at AAA home level during authentication. The SF's are store in the MS context at S-IWK level;

SF's stored at S-IWK level are not used for GSM; and

SF's stored at S-IWK level will be provided by S-IWK in R4 HO request during HO from GSM to WiMAX.

Regarding the GSM-WiMAX inter-working WiMAX Service Flows, GSM→WiMAX HO (MS has entered WiMAX prior to GSM):

MS sends MOB-MSHO-REQ to S-IWK;

S-IWK receives R4 HO REQ from serving ASN-GW;
The R4 HO REQ carries current SF's features (latency, jitter, throughput); and
S-IWK stores SF's features in MS context;
S-IWK does not map WiMAX SF's to GSM entities;

S-IWK replies R4 HO RSP with success indication for each SF; and

When MS will move to WiMAX, S-IWK will provide SF's stored in MS context to target ASN-GW.

Regarding the GSM-WiMAX inter-working WiMAX Service Flows, WiMAX→GSM HO:

MS sends MOB-MSHO-REQ to S-IWK through signaling agent;

S-IWK retrieves SF's from MS context and provide them into the R4 HO REQ it sends to target ASN-GW;

Target ASN-GW coordinates with target BS to prepare SF's requested by MS and build R4 HO RSP accordingly. Each SF can be accepted or rejected;

S-IWK receives R4 HO RSP and does not record individual SF indication (accept/reject);

MS sends MOB-MSHO-IND, moves to WiMAX and start ranging;

Target BS set MS in HO process optimization during ranging and SF's are resumed; and

If SF HO fails or network forces MS to perform (re)entry, SF's are deleted and only BE SF's are created/activated during HO.

Embodiments of the present invention define a WiMax optimized mechanism to handle roaming of a mobile terminal between 3GPP and WiMax networks on the basis of a loosely-coupled inter-working architecture. The mechanism may rely on an intermediate function (inter-working function) that bounds 3GPP and WiMax core networks together in a dual and transparent way (no modification of core networks is needed). The mechanism may use the WiMax R4 interface to optimize (on WiMax side only) handovers between 3GPP and WiMax.

Embodiments of the present invention as illustrated for example in FIG. 15, 16, 17 may coordinate 3GPP/WiMax handovers on the WiMax side using the R4 interface. The coordination may be done transparently by the Serving IWK intermediate node that implements the inter-working function as depicted in FIG. 15. Embodiments of the present invention as illustrated for example in FIG. 15, 16, 17 may not optimize the 3GPP part of the handover, that is, 3GPP network entry may be performed when roaming from WiMax to 3GPP and a 3GPP network “forget” is performed when roaming from 3GPP to WiMax. The 3GPP side optimization is not necessarily required.

FIG. 15 depicts 3GPP-WiMax optimized handover architecture according to an embodiment of the present invention. The Serving IWK node makes a 3GPP Packet core appear as an ASN-GW to the WiMax Home Network.

Terminal handovers from/to WiMax network may be managed in a coordinated manner by the Serving IWK function using R4 interface (WiMax standardized). The Serving IWK may make the ASN-GW believe a regular WiMax handover occurs.

Regular WiMax handovers are initiated by the terminal and include 3 steps: Handover preparation, Handover execution, and Handover post-execution. Handover post-execution is also called “relocation”. WiMax allows either “FA relocation only” or “Full relocation”. In “FA relocation only”, the MIP client and AAA authenticator stay in the serving ASN-GW while the FA is relocated (moved) from serving ASN-GW to target ASN-GW. In “Full relocation”, the MIP client, AAA authenticator and FA are relocated (moved) from serving ASN-GW to target ASN-GW. The “Full relocation” implies full WiMax re-authentication after handover. Embodiments of the present invention as illustrated for example in FIGS. 15 to 17 may use “FA relocation only”.

In WiMax, handovers are initiated by the terminal after cell reselection. This standard mechanism is used by the Serving IWK to detect a handover from WiMax to 3GPP. In 3GPP, there is no signaling originated from the terminal to initiate the handover. Embodiments of the present invention as illustrated for example in FIGS. 15 to 17 may use an application-level signaling between the terminal and the Serving IWK. The terminal side of the application is called the “signaling agent”, the Serving IWK side of the application is called the “signaling manager”. The signaling agent and manager communicate over a regular TCP/IP stack.

Embodiments of the present invention as illustrated for example in FIGS. 15 to 17 may address handovers from WiMax to 3GPP and handovers from 3GPP to WiMax as detailed below. Names used when denoting WiMax R4 interactions may, for example, be those used in current Alcatel-Lucent ASN-GW implementations. These names easily map to R4 standard names.

Embodiments of the present invention as illustrated for example in FIGS. 15 to 17 may provide the following mechanism to achieve a seamless WiMax to 3GPP handover. This mechanism includes two phases: Handover preparation and handover execution (including post-execution).

In the handover preparation the terminal may perform cell reselection and may select the 3GPP network as a target system. It may then send a Handover Request and may specify in the BSID list the “fake” BSID associated to the Serving IWK that is used when 3GPP is target of a handover.

The Serving ASN-GW may select the proposed BSID and may transmit in turn a Handover Preparation Request to the Serving IWK associated to the “fake BSID” (configured in WiMax BS/ASN-GW topology map). The Handover Preparation Request may carry the following essential information: MS MAC@ (WiMax terminal MAC address); HoA (WiMax terminal Home Address); HA@ (WiMax terminal Home Agent address); and Serving ASN-GW Upload IP@ (tunnel termination for data to terminal until handover execution completes).

The Serving IWK may acknowledge the Handover Preparation Request and may setup the GRE tunnel toward the serving ASN-GW to deliver data to the terminal (serving WiMax BS will be used) while handover execution is not yet achieved.

The serving ASN-GW may reply to the handover request to the terminal and may notify the Serving IWK when handover is ready to be executed. At the time, the Serving IWK must be prepared to accept terminal in 3GPP network.

In handover execution, depending on its capabilities, the terminal might attach to 3GPP prior to start WiMax handover execution. To start handover execution, the terminal may send a Handover Indication to the serving BS. At that time, from WiMax to 3GPP point of view, the terminal may be considered as entering 3GPP.

When entering 3GPP, the terminal may attach to the network and perform PDP context setup toward the Serving IWK. The terminal may request an IP@ using either PPP or non-transparent PDP context type.

Since the Serving IWK has stored the WiMax context coming from old ASN-GW on the R4 interface, it can resolve the PDP context setup using the HoA associated to the terminal in this context. At that time, the PDP context is usable from the terminal.

The Serving IWK completes the handover on WiMax using post-handover procedure. It first sends an Association Indication to the old ASN-GW indicating it now holds the terminal. The Indication is confirmed by the old ASN-GW. The Serving IWK, then request “FA relocation” to the old ASN-GW that provides in reply, the necessary MIP keys to be used to update the current MN-HA (and possibly FA-HA) MIP registration.

When “FA relocation” completes, the GRE tunnel between old ASN-GW and Serving IWK may be released after being purged to/from the terminal. Since only the FA is relocated, the MIP client and authenticator remains in the old ASN-GW until the terminal re-authenticate again.

In 3GPP to WiMax handover embodiments of the present method and apparatus may provide the following mechanism to achieve a seamless 3GPP to WiMax handover. This mechanism includes two phases: Handover preparation and handover execution (including post-execution).

In handover preparation the terminal may perform cell reselection and may select the 3GPP network as target system (not described). Because no terminal handover signaling is defined by 3GPP, the terminal may use a dedicated Signaling agent (running as a permanent task on the terminal) to send a Handover Request to the Serving IWK.

The Serving IWK may select the target (new) BSID given its own “fake” BSID and the WiMax BS/ASN-GW topology configuration map. It may then transmit a Handover Preparation Request to the target ASN-GW. The Handover Preparation Request carries the following essential information: MS MAC@ (WiMax terminal MAC address); HoA (WiMax terminal Home Address); HA@ (WiMax terminal Home Agent address); and Serving IWK Upload IP@ (tunnel termination for data to terminal until handover execution completes).

The target ASN-GW acknowledges the Handover Preparation Request and may setup the GRE tunnel toward the serving IWK to deliver data to the terminal (3GPP BS will be used) while handover execution is not yet achieved.

The Serving IWK signaling manager may reply to the handover request to the terminal signaling agent and may notify the target ASN-GW when handover is ready to be executed. At the time, the target ASN-GW must be prepared to accept terminal in the WiMax network (start ranging). Note that the terminal Handover Indication may be not required to be received by Serving IWK.

In the handover execution the terminal may attach to the target BS and the target ASN-GW may send an Association Indication to the Serving IWK to indicate it has control on the terminal. The Serving IWK may reply to the Association Indication and prepares to post-execution.

The target ASN-GW, may then request “FA relocation” to the serving IWK that provides in reply, the necessary MIP keys to be used to update the current FA-HA MIP registration by the target ASN-GW.

When “FA relocation” completes, GRE tunnel between Serving IWK and target ASN-GW and may be released after being purged to/from the terminal. Since only the FA is relocated, the MIP client and authenticator remains in the Serving IWK until the terminal re-authenticates again.

FIG. 16 is a flow diagram that depicts sequences and data for WiMax to 3GPP optimized handover with R4 according to embodiments of the present invention.

The following steps are illustrated in FIG. 16:

A MIP Tunnel is established between serving ASN GW and HA.

Cell reselection is performed for the MS.

MS sends MOB-MSHO-REQ (BSID list) to ASN GW.

ASN GW sends IWHO_PREP_REQ (tBSID, MS-MAC@, HoA, HA@, sASN-GW-UL-IP@) to Serving IWK.

MS Context (HoA, HA@, MIP keys) is stored at IWK.

IWK sends IWHO_PREP_CNG (MS-MAC@, sIWK-DL-IP@) to ASN GW.

DL (Downlink) and UL (Uplink) GRE tunnels are established between ASN GW and IWK.

ASN GW sends IWHO_SYNC_IND (tBSID, MS-MAC@)) to IWK.

3GPP entry is performed.

PDP Context is setup between MS and IWK (IP@=HoA).

IWK sends IW_ASSO_IND (MS-MAC@) to ASN GW.

ASN GW sends IW_ASSO_RSP to IWK.

IWK sends IWHO_RELOC_REQ (MS-MAC@) to ASN GW.

ASN GW sends IWHO_RELOC_ACK (MIP Keys) to IWK.

MIP tunnel is established between IWK and HA. FIG. 17 is a flow diagram that depicts sequences and data for 3GPP to WiMax optimized handover with R4 according to embodiments of the present invention.

The following steps are illustrated in FIG. 17.

A MIP Tunnel is established between serving IWK and HA.

WiMAX detection is performed for the MS.

MS sends MOB-MSHO-REQ (BSID list, MS-MAC@) to serving IWK.

IWK sends IWHO_PREP_REQ (tBSID, MS-MAC@, HoA, HA@, sIWK-UL-IP@) to target ASN GW.

ASN GW sends IWHO_PREP_CNF (MS-MAC@, sASN-GW-DL-IP@) to IWK.

DL (Downlink) and UL (Uplink) GRE tunnels are established between ASN GW and IWK.

IWK sends IWHO_SYNC_IND (tBSID, MS-MAC@) to ASN GW.

WiMAX ranging is performed.

ASN GW sends IW_ASSO_IND (MS-MAC@) to IWK.

IWK sends IW_ASSO_RSP to IWK.

ASN GW sends IWHO_RELOC_REQ (MS-MAC@)) to IWK.

IWK sends IWHO_RELOC_ACK (MIP keys) to IWK.

MIP tunnel is established between ASN GW and HA. Advantages of embodiments of the present invention as illustrated for example in FIGS. 15 to 17 include: the 3GPP/WiMax optimized handover is utilized by a mobile terminal in 3GPP and WiMax networks without impacting the 3GPP and WiMax networks, and this does not require nodes of existing 3GPP and WiMax infrastructure to be modified in order to provide optimized handover.

Embodiments of the present invention as illustrated for example in FIGS. 18 to 30 define a mechanism to optimize the handover from WIMAX to 3GPP systems for a dual mode mobile. The principle is based on the handover preparation procedure of WiMAX combined with the Network-requested PDP context activation procedure of 3GPP. This provides in advance the 3GPP connectivity (Make before Break). Embodiments of the present method and apparatus are useful for real time applications such as voice over IP. Embodiments of the present invention as illustrated for example in FIGS. 18 to 30 add a S-IWK (Serving Interworking node) between GGSN and HA as follows. This node emulates ASN-GW functions for the 3GPP interworking; it is also in charge to setup the network requested PDP context activation procedure in the aim to establish the 3GPP connection before to break the WiMAX connection.

Based on the inter ASN-GW mobility, the handover from WIMAX to 3GPP mechanism consists of three steps. The Mobile Station is attached under GPRS at the power-on and registered in HLR. Before entering under 3GPP RAN coverage area, the MS performs the two first steps below. When the MS is connected to the 3GPP RAN, the S-IWK can start the Mobile IP registration procedure.

FIG. 18 depicts 3GPP and WiMax systems prior to a handover according to an embodiment of the present invention. The following describes one example of Handover preparation according to an embodiment of the present invention. First, the MS requests handover to serving ASN-GW with as candidate the target S-IWK, and second the Serving ASN-GW sends MS context to target S-IWK containing MS ID, HA @, MS IP @, MIP keys via R4 interface.

FIG. 19 depicts 3GPP and WiMax systems during handover according to an embodiment of the present invention. The following describes one example of Handover execution according to an embodiment of the present invention. First, the MS sends HO indication to serving ASN-GW, then the Serving ASN-GW informs the target S-IWK with a HO-Confirmation message, the Target S-IWK then sends a Network requested PDP context activation to GGSN, Serving ASN-GW sends data through GRE tunnel toward target S-IWK, and finally S-IWK forwards data towards MS via GGSN.

FIG. 20 depicts 3GPP and WiMax systems after mobile IP registration according to an embodiment of the present invention. The following describes one example of Post-Handover according to the present method and apparatus. Target S-IWK performs MIP registration Handover from WIMAX to 3GPP RAN.

FIG. 21 is a flow diagram that depicts sequences and data regarding handover optimization according to an embodiment of the present invention. In one embodiment the procedural functioning of the handover optimization may be as follows:

1. Before leaving the WiMAX coverage, the MS communicates to the serving ASN-GW, the target S-IWK identifier via a MOB_MSHO-REQ message.

2. The serving ASN-GW informs the target S-IWK about an incoming HO-Req from MS. This message contains the MS context with MS ID (NAI), MS IP @ (HoA), HA IP @ and keying material.

3. The target S-IWK sends in reply HO-Rsp.

4. When the MS is attached to 3GPP, it sends MOB_HO-IND. The serving ASN-GW sends HO-cnf to the target S-IWK. The data are forwarded by the serving ASN-GW to the target S-IWK through a GRE tunnel.

5. The serving S-IWK sends a PDP PDU the GGSN. Then the GGSN initializes the Network-Requested PDP context activation procedure.

6. The GGSN may send Send Routing Information for GPRS message to HLR. The HLR determines the SGSN attached to the MS and returns Send Routing Information for GPRS ack message to the GGSN.

7. The GGSN sends a PDU Notification Request (PDP type, MS IP@, APN) message to the SGSN indicated by the HLR.

8. The SGSN sends a Request PDP context Activation message to request the MS to activate the indicated PDP context.

9. The MS sends an activate PDP context in static mode with the MS IP @ to SGSN.

10. The SGSN initiates the Create PDP Context Request procedure. After that, the data can be transferred from the target S-IWK to the MS under RAN coverage.

11. The Serving-IWK performs MIP registration to create a binding of the MS at the HA, setup the association between FA (Serving IWK) and HA during the service establishment procedure.

12. Packets transfer procedure: MS and Home CSN communications is established with uplink & downlink transfers of data packets.

The following sets forth some of the features of the systems depicted in FIGS. 22-30.

Regarding Procedures with PMIP-based Interworking solution (data services), there may be considered to be two parts:

Network entry, First Set-up=>Following major steps to be performed:
1. Network discovery and selection by terminal,
2. Connection setup,
3. User Authentication, Authorization,
4. Service Flow establishment, and
5. Mobile IP registration and tunnel establishment.

Inter-system Handover=>Re-Network entry:
To improve the performances of HO from WiMAX to 3GPP, the Network requested PDP context activation procedure is used.

FIGS. 22-24 (similar to FIGS. 18-20) depict Loosely-Coupled Interworking—WiMAX/3GPP mobility.

FIGS. 25-28 depict R4 optimized handover from WiMAX to 3GPP. In general, these figures represent the following:

1. Scan for downlink channel and establish connection with the BTS

2. Perform HO preparation
MS requests HO to serving ASN-GW
Serving ASN-GW sends MS context to target S-IWK with MIP keys (If ASN-GW is WiMax compliant, MIP keys can be transferred during handover preparation phase)

3. Perform HO execution
MS sends HO indication to serving ASN-GW
Target S-IWK sends a Network requested PDP context activation to GGSN
Serving ASN-GW sends data through GRE tunnel toward target S-IWK
S-IWK forwards data towards MS via GGSN

4. Perform post-HO
Target S-IWK performs MIP registration

The following steps are illustrated in FIG. 25.

1. MS sends HO Request to serving ASN-GW to initiate WiMAX HO preparation procedure.

2. Send MS context to Target ASN-GW with HA IP @, HoA, MIP keys.

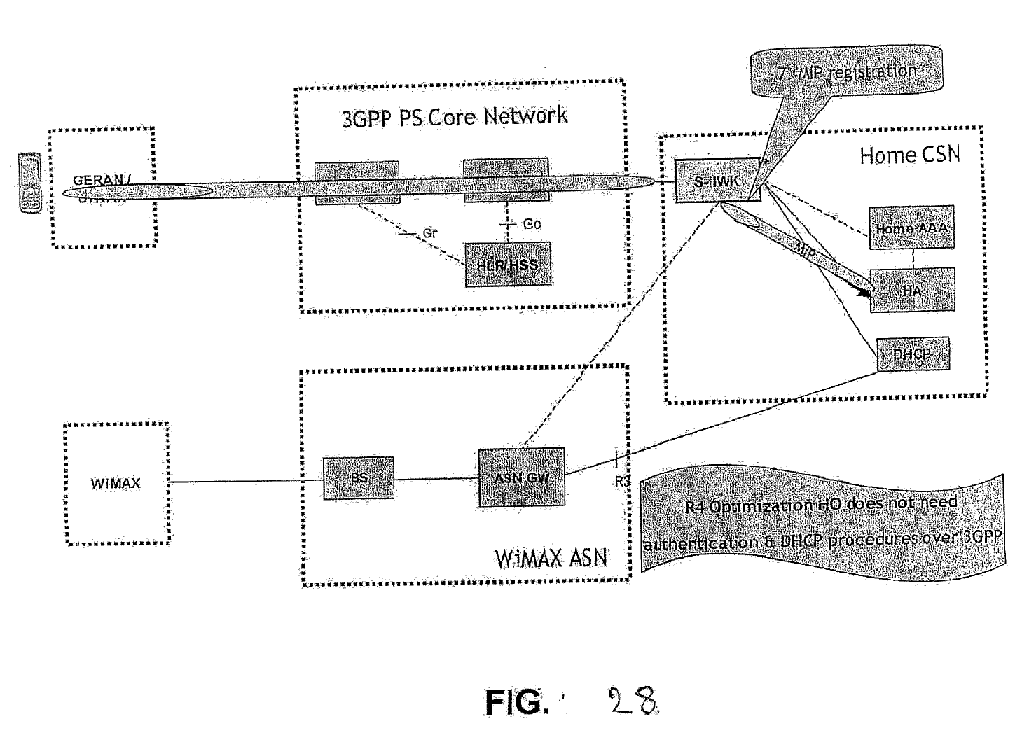

The following steps are illustrated in FIG. 26.

3. MS sends HO Indication to serving ASN-GW to initiate WiMAX HO execution.

4. Serving ASN-GW sends HO Reloc. request to the target S-IWK.

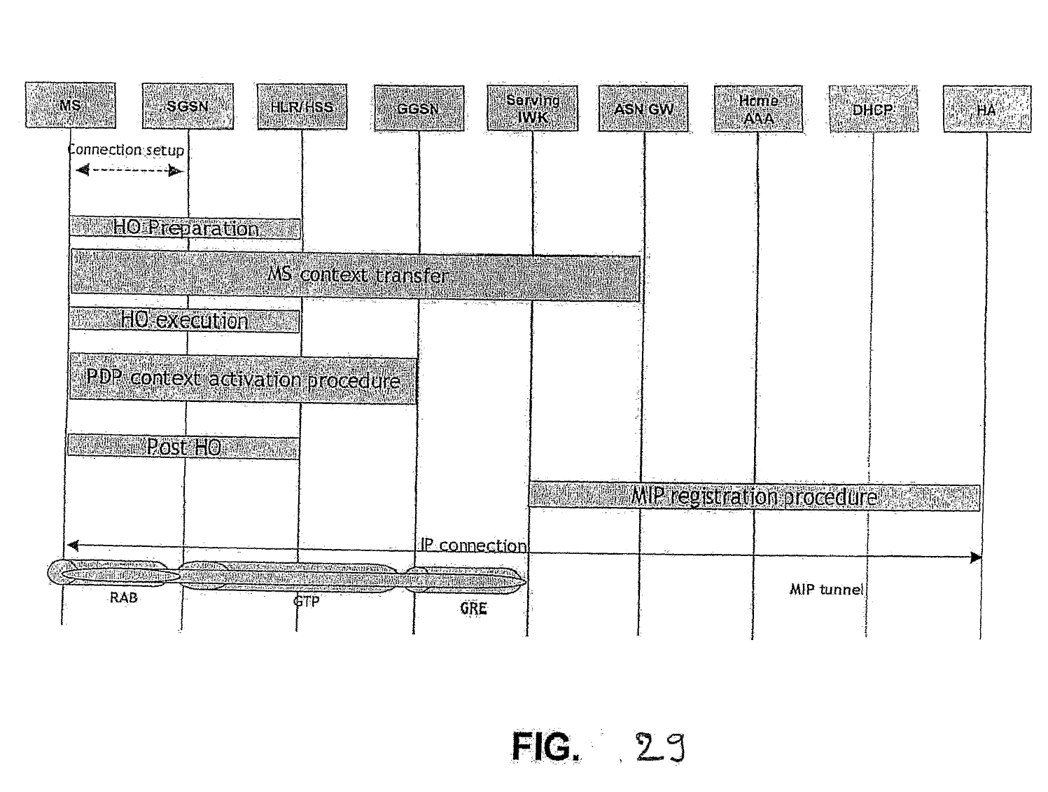

The following steps are illustrated in FIG. 27.

5. PDP Context Activation procedure.

6. Network requested PDP context activation procedure.

The following step is illustrated in FIG. 28.

7. MIP Registration

R4 Optimisation HO does not need authentication & DHCP procedures over 3GPP.

FIG. 29 depicts Handover WiMAX TO 3GPP in an embodiment of the present invention.

The following steps are illustrated in FIG. 29.

Connection Setup,

HO preparation,

HO execution,

PDP Context Activation procedure,

Post HO,

MIP registration procedure,

IP connection.

FIG. 30 (similar to FIG. 21) depicts further Handover WiMAX TO 3GPP in an embodiment of the present invention.

Advantages of embodiments of the present invention as illustrated for example in FIGS. 18 to 30 include that the change of network point of attachment from WiMAX to 3GPP RAN with a short delay is due to a make before break procedure, and that the active services are maintained during all of the procedure.

Embodiments of the present invention as illustrated for example in FIGS. 18 to 30 satisfy service continuity requirements with the following main advantages: minimize the packet loss or latency during a handover; no new protocols are required; and the handover occurs without impact on the existing 3GPP & WiMAX networks.

Embodiments of the present invention as illustrated for example in FIGS. 31 to 36 define a mechanism that allows a mobile terminal to obtain a common IP address when 3GPP and WiMax networks are used as underlying radio access technologies. The mechanism relies on an intermediate function (inter-working function) that bounds 3GPP and WiMax core networks together in a dual and transparent way (no modification of core networks is needed). The mechanism hides to separation and disparity of IP address configuration by providing transparent adaptation of configuration mechanisms.

Embodiments of the present invention as illustrated for example in FIGS. 31 to 36 may retrieve the IP address from WiMax network when providing the address to the mobile in 3GPP network. The retrieval may be done transparently by the Serving IWK intermediate node that implements the inter-working function as depicted in FIG. 31.

FIG. 31 depicts 3GPP-WIMAX common IP address architecture according to an embodiment of the present invention. In this embodiment the Serving IWK node makes a 3GPP Packet core appear as an ASN-GW to the WiMax Home Network. The common IP address used by a terminal as its home address for both 3GPP and WiMax networks is managed in the WiMax home network by a DHCP server. IP address configuration in each network is performed as follows:

Regarding an IP address configuration in a WiMax network, the terminal may attach to the WiMax network and receives the DHCP server address during AAA authentication. The terminal may then requests the DHCP server to deliver an address given its MAC address or NAI. The DHCP server may retrieve the IP address of the terminal from its address database (or file) given the terminal identity (MAC address or NAI) and return it to the terminal. The returned address may then be configured at the terminal level as the IP address.

Regarding an IP address configuration in a 3GPP network, the terminal may attach to the 3GPP network and request non-transparent PDP Context creation, selecting the Serving IWK through APN field and providing its WiMax NM or MAC address through the PCO field. When the GGSN handles such a PDP context creation, it may build and send a DHCP request to the Serving IWK mapping the PCO field to a DHCP field. The Serving IWK may retrieve the WiMax DHCP server address associated to the terminal by looking in its configuration database (file) given the terminal identity retrieved from the DHCP field (MAC address or NAI).

The Serving IWK may now act as a DHCP client to request to the WiMax DHCP server the WiMax IP address of the terminal providing the terminal identity in the new DHCP request. The DHCP server may retrieve the IP address of the terminal from its address database (or file) given the terminal identity (MAC address or NAI) and return it to the Serving IWK. The Serving IWK returns the IP address through DHCP in response to the original GGSN DHCP request.

The GGSN may reply to the PDP context creation providing the IP address returned in the DHCP response. The returned address is then configured at the terminal level as the IP address.

The IP address configuration in WiMax network is the regular mechanism defined by WiMax forum. Embodiments of the present method and apparatus just require the usage of a DHCP server to inter-work with 3GPP. In particular, IP address configuration by AAA and HA in WiMax is not compatible with the embodiments of the present method and apparatus.

The IP address configuration in 3GGP network is the aim of the embodiments of the present method and apparatus. Detailed aspects of the invention are described in the chart below.

FIG. 32 is a flow diagram that depicts sequences and data for an address configuration mechanism from WiMax to 3GPP according to an embodiment of the present invention. In one embodiment the address configuration mechanism may be as follows:

MS scans for downlink channel and establish connection with the BTS/Node B.

MS performs an Attach procedure: MS connects to GPRS Core Network (SGSN).

MS sends an activate PDP context in IPv4 non-transparent access with a specific APN (APN (Access point name): identifies the ISP service provider (here “Home CSN”) in name form. It is stored in HLR. The GGSN retrieves from APN, the Serving IWK IP @.) to SGSN. The PCO field contains the WiMax terminal identity (MAC@ or NAI) data needed for MS IP@ retrieval from Home CSN DHCP server.

The SGSN sends a Create PDP Context Request message to the GGSN containing the PCO field.

Upon reception of the Create PDP context Request, the GGSN performs DHCP offer to the Serving IWK mapping PCO field containing WiMax identity to DHCP field.

The Serving IWK starts the DHCP procedure towards the WiMax DHCP server. The Serving IWK acts as DHCP relay or client.

The Serving-IWK receives the MS IP@ for the terminal from WiMax DHCP server and delivers it to the GGSN.

The GGSN activate the PDP context with the MS IP@ that is returned to the MS for configuration. The MS IP@ is renewed transparently by the Serving IWK during operation.

It is an advantage of the embodiments of the present invention as illustrated for example in FIGS. 31 to 36 that the common IP address may be allocated to a mobile terminal in 3GPP and WiMax networks without impacting the 3GPP and WiMax networks.

Embodiments of the present invention as illustrated for example in FIGS. 31 to 36 do not require nodes of existing 3GPP and WiMax infrastructure to be modified in order to provide unique MS IP address allocation.

Regarding Procedures with PMIP-based Interworking solution (data services), there may be considered to be two parts:

Network entry, First Set-up=>Following major steps to be performed:

1. Network discovery and selection by terminal,

2. Connection setup,

3. User Authentication, Authorization,

4. Service Flow establishment, and

5. Mobile IP registration and tunnel establishment.

Inter-system Handover=>Re-Network entry:

The same IP @ is used (provided by the DHCP server).

The following sets forth some of the features of the systems depicted in FIGS. 33-36.

Each MS contains information (from manufacturer) on a SIM Card.

The MS follows the following general procedures:

1. Scan for downlink channel and establish connection with the BTS/BS;

2. Attach procedure: MS connects to GPRS Core Network (SGSN);

3. Perform registration in HLR/HSS (authentication);

4. Session open procedure (Establish IP connectivity): MS sends an activate PDP context with a specific APN for access to the Serving-IWK using Non transparent access mode. MS IP @ is allocated by WiMAX Home CSN (For no optimized handover, the same MS IP @ as the one allocated during the network entry, is allocated. For this, DHCP relay function is used in ASN-GW and the MSISDN is used in the DHCP messages) with DHCP procedure. The S-IWK performs a MIP registration (PMIPv4); and

5. Packets transfer procedure: GGSN forwards data from/towards Serving-IWK using GRE tunnel.

FIG. 33 depicts 3GPP Network entry scenario in an embodiment of the present invention.

The following steps are illustrated in FIG. 33.

1. GTP Tunnel Setup.

2. DHCP procedure to get HoA (MS IP@).

3. MIP registration.

FIG. 34 depicts 3GPP network (re-)entry in an embodiment of the present invention.

The following steps are illustrated in FIG. 34.

Connection Setup.

Attach Req/Acc between MS and SGSN, and Authentication between SGSN and HLR/HSS.

MS sends Activate PDP Context Request (NSAPI, APN, requested QoS, PCO) to SGSN.

SGSN sends CREATE PDP CONTEXT Request (PDP type, IMSI, TEID, NSAPI, APN, MSISDN, negotiated QoS, PCO) to GGSN.

Access Request/accept between GGSN and Home AAA.

GGSN sends DHCP Discover (GGSN, MAC @, MSISDN).

Exchanges between IWK and DHCP.

IWK sends DHCP Offer (MS T@) to GGSN.

GGSN sends DHCP Request (GGSN MAC @, MSISDN, MS IP@) to IWK.

Exchanges between IWK and DHCP. DHCP sends DHCP Ack (MS IP@, lease time) to IWK.

IWK sends MIP RRQ (HA@, HoA, lifetime, CoA, MN-HA AE, FA-HA AE) to HA.

Exchanges between HA and Home AAA.

HA sends MIP Registration Response to IWK.

MIP tunnel is established between IWK and HA.

IWK sends DHCP Ack (MS IP@, lease time) to GGSN.

GGSN sends Create PDP Context Response (MS IP@) to SGSN.

SGSN sends Activate PDP Context Accept (MS IP@, negotiated QoS) to MS.

GTP tunnel is established between SGSN and GGSN.

IP application service establishment.

Regarding WiMAX Network entry, break before make HO, each MS contains information (from manufacturer), such as, 48-bit universal MAC address+IMSI+MSISDN.

The MS may follow the following general procedures:

1. Scan for downlink channel and establish connection with the BS;

2. Authorize MS and perform key exchange (using PMKv2 protocol), combines two protocols, PKMv2 & EAP over SIM (AKA);

3. Perform registration with BS;

4. Establish IP connectivity (via DHCP+PMIP) (note: For a no optimized handover, the same MS IP @ as the one allocated during the network entry is allocated. For this, the ASN-GW supports the DHCP relay function.)

5. Set-up provisioned connections (service flows according to subscription)

FIG. 35 depicts WiMAX Network entry in an embodiment of the present invention.

The following steps are illustrated in FIG. 35:

1. Full re-authentication

2. DHCP procedure

3. MIP registration.

FIG. 36 depicts further WiMAX Network entry in an embodiment of the present invention.

The following steps are illustrated in FIG. 36.

Connection set-up between MS and ASN GW.

Access Authentication & Authorization between ASN GW and AAA.

AAA sends MAP-send-auth-info req (IMSI) to HLR.

HLR sends MAP-send-auth-info resp (auth. Vector, SRES, Kc) to AAA.

MS sends DHCP Discover (chaddr=MAC, client-id=MSISDN, [Requested IP@, IP@lease time])

ASN GW sends DHCP Discover (chaddr=MAC, client-id=MSISDN, [IP@, IP@lease time]).

DHCP sends DHCP Offer (chaddr=MAC, client-id=MSISDN, [IP@, IP@lease time]) to ASN GW.

ASN GW sends DHCP Offer (chaddr=MAC, client-id=MSISDN, MS IP@, IP@lease time]) to MS.

MS sends DHCP Request (chaddr=MAC, client-id=MSISDN, MS IP@) to ASN GW.

ASN GW sends DHCP Request (chaddr=MAC, client-id=MSISDN, MS IP@) to DHCP.

DHCP sends DHCP Ack (chaddr=MAC, client-id=MSISDN, MS IP@, lease time) to ASN GW (DHCP server returns the same IP @ as in the 3GPP access system).

ASN GW sends DHCP Ack (chaddr=MAC, client-id=MSISDN, MS IP@, lease time) to MS.

Service Flow Creation.

ASN GW sends MIP RRQ (HA@, HoA, lifetime, CoA=FA-CoA, MN NAI, MN-HA AE, FA-HA AE) to HA.

HA sends Access request to AAA.

AAA sends Access Accept to HA.

HA sends MIP Registration Response to ASN-GW.

MIP tunnel is established between ASN GW and HA

IP application service establishment.

In order to allow the WiMax/3GPP mobility, a solution is to use the same mechanism in 3GPP access system as in WiMax system in the aim to keep the same IP address in both access networks.

This is possible by using MIP or PMIP procedures. For this, the first idea is to add a new node beside the GGSN (General Packet Radio Service), that acts as ASN-GW (of WiMax). This node is in charge of the authentication procedure, the DHCP procedure to get an IP address and the MIP registration. Unfortunately, WiMax and 3GPP access network standards provide separate and disparate methods to. Indeed, these procedures present incompatible data to obtain the same result.

Embodiments of the present invention as illustrated for example in FIGS. 37 to 45 define mechanism that allows a new node, S-IWK, to obtain common data (NAI and IP address) for a MIP registration procedure at each (re-) entry networks in 3GPP or WiMax access network. The IP address is retrieved from the WiMax network when providing the address to the mobile terminal in the 3GPP network. The S(Serving)-IWK intermediate node that implements the inter-working function does the retrieval transparently.

FIG. 37 depicts a WiMax access network. In a WiMax access network, the MS performs a WiMax RAN connection set up Access Authentication and Authorization for network entry. The user authentication will be handled between the MS and an AAA server using an EAP method. The NAI is the identity submitted by the client during the access authentication request. Then MS performs DHCP to get a local IP address (HoA). The DHCP messages use as a client-identifier the NAI. So, the ASN-GW performs MIP registration to create the binding of the MS at the Home Agent. The ASN-GW informs the HA of the HoA (local IP address), CoA (ASN-GW user plane address) with NAI as identifier. FIG. 38 depicts a 3GPP access network. In the 3GPP access network, the MS performs an attachment procedure, then an activate PDP context procedure to establish a connection with the HA. For this, MS sends an activate PDP context in IPv4 non-transparent access with a specific APN (access point name) to SGSN. The APN identifies the ISP service provider (here “Home CSN”) in name form. It is stored in HLR. The GGSN retrieves from APN, the AAA server IP address and the DHCP server IP address.

The SGSN sends a Create PDP Context Request message to the GGSN. Upon reception of the Create PDP context Request, the GGSN performs the user authentication towards the AAA server based on RADIUS. Remote Authentication Dial In User Service (RADIUS) is an AAA (authentication, authorization and accounting) protocol for applications such as network access or IP mobility. It is intended to work in both local and roaming situations. The GGSN starts the DHCP procedure and the DHCP messages contain the MSISDN as client-identifier, not the IMSI. The MSISDN is a number uniquely identifying a subscription in a GSM or UMTS mobile network. Simply put, it is the telephone number to the SIM card in a mobile/cellular phone.

FIG. 39 depicts an inter-working architecture according to embodiments of the present invention for a WiMax network and a 3GPP network.

The architecture illustrated in FIG. 39 comprises:

a dual-mode WiMAX/3GPP Mobile Station MS (or UE),

a WiMAX network comprising ASN and Home CSN, ASN in turn comprising entities such as BS and ASN-GW, and Home CSN in turn comprising entities such as AAA Server, Home Agent HA and DHCP Server,

a 3GPP access network comprising RAN (such as GERAN/UTRAN) and PS Core Network, such as 2G/3G PS Core Network, in turn comprising entities such as SGSN, GGSN, HLR/HSS and 3GPP AAA Server.

A 3GPP/WiMAX interworking node (noted IWK) is introduced. IWK connects with the 3GPP Packet Core Network using 3GPP Gi interface, and with the WiMAX Connectivity Service Network CSN using WiMAX R3 interface. IWK interfaces with a GGSN in the 3GPP Packet Core Network using 3GPP Gi interface.

Home CSN is considered by GGSN as an ISP identified by a dedicated APN.

In the illustrated embodiment, IWK emulates ASN-GW:

R3 support

Authenticator

PMIP Client/FA

DHCP relay.

In embodiments of the present invention the IP address is retrieved from the WiMax network when providing the address to the mobile terminal in the 3GPP network. The Serving-IWK intermediate node that implements the inter-working function, as depicted in FIG. 39, does the retrieval transparently.

The common IP address of the MS (its HoA) for both 3GPP and WiMax access networks is managed in the Home CSN network by a DHCP server. In this goal, the S-IWK needs to obtain an NAI based on IMSI. For this, the S-IWK supports the Proxy-AAA server function to get the IMSI and the MSISDN of the user thanks to the RADIUS process between the GGSN and the AAA server.

Embodiments of the present invention as illustrated for example in FIGS. 42 to 45 provide, in general, a MS context in an S-IWK containing the MSISDN, IMSI and IP address for the usage of a DHCP server and HA belonging to the WiMax CSN network. So, the S-IWK provides the following functions: Proxy-AAA server, DHCP relay, and MPA (PMIP client+FA).

FIG. 40 depicts MIP-based inter-working function according to an embodiment of the present invention for a WiMax network and a 3GPP network. One target of the present method and apparatus is service continuity. This includes maintaining active services, changing network point of attachment without changing IP address, using a common HA to have IP address unchanged during HO, minimizing the packet loss or latency during a handover, location change frequency being greater than 1 second, and initiation by MS. The MS characteristics may be only one radio is activated at any time to minimize power consumption of a mobile terminal. In regards to mobility characteristics PMIP is collocated with Authenticator and FA. Furthermore, the impact on the existing 3GPP & WiMax networks is minimized.

FIG. 41 depicts an interworking reference model that is based on an SAE architecture.

FIG. 42 depicts a flow diagram that depicts sequences and data for an embodiment of a (RE-)Entry 3GPP network procedure according to an embodiment of the present invention. Operation of this embodiment is as follows:

1. The terminal attaches to the 3GPP network and requests non-transparent PDP Context creation, selecting the S-IWK through APN.

2. When a GGSN receives a Create PDP context Request message, the GGSN sends a RADIUS access-request to the AAA server via S-IWK that acts as proxy-AAA server. This message contains the MSISDN and the IMSI of the user: this information is stores as MS context by S-IWK. The AAA server authenticates and authorizes the user. RADIUS shall also return the HA IP address to the S-IWK that forwards this message to the GGSN.

3. Then, the GGSN starts the DHCP procedure. The S-IWK acts as DHCP relay. The S-IWK retrieves the DHCP server address by looking in its configuration database (file). The S-IWK replaces the MSISDN by the NAI (based IMSI) in the client-identifier field to get the same MS's IP address (HoA) in the both access networks.

4. The S-IWK returns the IP address through DHCP in response to the original GGSN DHCP request.

5. The GGSN replies to the PDP context creation providing the IP address returned in the DHCP response.

6. The returned address is then configured at the terminal level as the IP address.

7. The S-IWK performs the MIP registration procedure using the NAI (based IMSI), HoA and CoA (S-IWK user plane address).

FIG. 43 depicts a 3GPP network entry scenario according to an embodiment of the present invention. Some of the principals include standard interfaces 3GPP and WiMax, inter-working function WIMAX to 3GPP localized in a dedicated box (S-IWK), getting the same IP in both areas WiMax and 3GPP. Solutions include IP PDP in a non-transparent access mode, and use of a DHCP relay function in ASN-GW & S-IWK.

Regarding 3GPP network entry & HO (re-entry), each MS contains the following information (from manufacturer) in regards to the SIM Card:

1. Scan for downlink channel and establish connection with the BTS/BS;

2. Attach procedure wherein MS connects to GPRS Core Network (SGSN);

3. Perform registration in HLR/HSS (authentication);

4. Session open procedure (Establish IP connectivity) wherein MS sends an activate PDP context with a specific APN for access to the Serving-IWK using Non transparent access mode, MS P @ being allocated by WiMax Home CSN with DHCP procedure and the S-IWK performing a MIP registration (PMIPv4); and

5. Packets transfer procedure wherein GGSN forwards data from/towards Serving-IWK using GRE tunnel. For no optimized handover, the same MS IP @ as the one allocated during the network entry, is allocated. For this, DHCP relay function is used in ASN-GW and the MSISDN is used in the DHCP messages.

FIGS. 44 and 45 depict a WiMax network entry scenario according to the present method and apparatus. Regarding this phase of the present method and apparatus each MS contains the following information (from manufacturer) in 48-bit universal MAC address+IMSI+MSISDN:

1. Scan for downlink channel and establish connection with the BS;

2. Authorize MS and perform key exchange (using PMKv2 protocol), and combine two protocols, which are PKMv2 & EAP over SIM (AKA);

3. Perform registration with BS;

4. Establish IP connectivity (via DHCP+PMIP); and

5. Set-up provisioned connections (service flows according to subscription). For a no optimized handover, the same MS IP @ as the one allocated during the network entry is allocated. For this, the ASN-GW supports the DHCP relay function. Embodiments of the present method and apparatus provide, in the context of GSM to WiMax, session continuity, availability of new services (high bandwidth), and bandwidth improvement for running services. Embodiments of the present method and apparatus provide, in the context of GSM to WiMax, session continuity, adaptation to limited bandwidth consuming services, and bandwidth adaptation for running services.

Advantages of embodiments illustrated for example in FIGS. 42 to 45 include that they provide common IP address allocation to a mobile terminal in 3GPP and WiMax network without impacting 3GPP and WiMax networks and existing protocols. Advantages also include that this does not require nodes of existing 3GPP and WiMax infrastructure to be modified in order to provide unique MS IP address allocation.

In one aspect of the present invention, in an embodiment, there is provided an architecture for interworking between WiMAX and 3GPP networks, said architecture comprising:

an interworking node IWK which connects with the 3GPP Packet Core Network using 3GPP Gi interface, and with the WiMAX Connectivity Service Network CSN using WiMAX R3 interface.

In an embodiment, IWK interfaces with a GGSN in the 3GPP Packet Core Network using 3GPP Gi interface.

In an embodiment, IWK comprises a Foreign Agent FA.

In an embodiment, IWK comprises Proxy-AAA-Server, DHCP relay, and a Foreign Agent FA.

In an embodiment, Home CSN is considered by GGSN as an ISP identified by a dedicated APN.

In another aspect there is provided a method for handover between WiMAX and 3GPP networks using such architecture. In an embodiment, said method comprises the steps of:

handover preparation,

handover execution.

In an embodiment, a handover comprises the steps of

IWK managing in a coordinated way handovers from/to WiMAX network, using WiMAX R4 interface.

In an embodiment, the preparation of a handover from WIMAX to 3GPP comprises the steps of:

a Mobile Station MS sending to the WiMAX network a Handover Request MOB-MSHO-REQ message specifying in a BSID list a fake Base Station Identity BS ID associated with IWK,

ASN-GW sending a R4 Handover Request R4 HO_Req message to IWK.

In an embodiment, the preparation of a handover from WIMAX to 3GPP comprises a step of:

IWK storing in a Mobile Station MS context, WiMAX context information received in a R4 Handover Request R4 HO_Req message.

In an embodiment, the preparation of a handover from WiMAX to 3GPP comprises a step of:

IWK storing in a Mobile Station MS context, WiMAX context information received in a R4 Anchor_DPF_Req message.

In an embodiment, said WiMAX context information comprises Home Address HoA, Home Agent Address HA @, and Mobile IP MIP keys.

In an embodiment, said handover preparation comprises a step of:

setting up a GRE tunnel between ASN-GW and IWK.

In an embodiment, the execution of a handover from WiMAX to 3GPP comprises the steps of:

upon attaching to the 3GPP network, a Mobile Station MS performing PDP context setup towards IWK, MS requesting an IP address using either PPP or non-transparent PDP context type,

IWK resolving the PDP context setup using the WiMAX Home Address HoA associated with the MS in a MS Context stored in IWK.

In an embodiment, the execution of a handover from WiMAX to 3GPP comprises the steps of:

upon attaching to 3GPP network, a Mobile Station MS sending a MOB_HO-IND message to the WiMAX network,

ASN-GW sending a R4 Handover Confirmation R4 HO_CNF message to IWK,

upon the forwarding of data by ASN-GW to IWK through a GRE tunnel, IWK sending a PDP PDU to GGSN,

GGSN initializing a Network-Requested PDP context activation procedure.

In an embodiment, the execution of a handover from WiMAX to 3GPP comprises a step of:

upon a Mobile Station MS attaching to 3GPP network, setting up a PDP context of IP non-transparent type and with static mode, MS requiring to use previously stored WiMAX Home Address HoA.

In an embodiment, the execution of a handover from WiMAX to 3GPP comprises the steps of:

IWK requesting FA relocation to ASN-GW,

ASN-GW providing in reply the necessary MIP keys to be used to update the current FA-HA registration.

In an embodiment, the preparation of a handover from 3GPP to WiMAX comprises a step of:

a Mobile Station MS using a dedicated Signaling Agent to send a Handover Request to IWK.

In an embodiment, the preparation of a handover from 3GPP to WiMAX comprises a step of:

IWK selecting a new Base Station Identity BS ID given its own fake BS ID and the WiMAX BS/ASN-GW topology configuration map.

In another aspect,there is provided a method for assigning a common IP address in WiMAX and 3GPP networks using such architecture. In an embodiment, said method comprises a step of:

retrieving a Mobile Station MS IP address from WiMAX network when providing the IP address to the MS in 3GPP network, transparently by IWK.

In an embodiment, said method comprises the steps of:

upon attaching to the 3GPP network, MS requesting non-transparent PDP Context creation, selecting IWK through APN field and providing its WiMAX Identity through the PCO field,

when handling the PDP context creation, GGSN building and sending a DHCP request to IWK, mapping the PCO field to a DHCP field,

IWK, acting as a DHCP relay or client, starting DHCP procedure towards WiMax DHCP Server,

IWK receiving the MS IP address from WiMax DHCP Server and delivering it to GGSN,

GGSN activating the PDP context with the MS IP address that is returned to the MS for configuration.

In an embodiment, said method comprises a step of:

constructing a Mobile Station MS context in IWK containing the MSISDN, IMSI and IP address of the MS for the usage of a DHCP server and Home Agent HA belonging to the WiMAX CSN.

In an embodiment, said method comprises the steps:

upon attaching to the 3GPP network, MS requesting non-transparent PDP Context creation, selecting IWK through APN,

upon receiving a Create PDP context Request message, GGSN sending a RADIUS Access Request message to WiMAX AAA Server, via S-IWK acting as proxy-AAA server, said message containing user's MSISDN and IMSI,

IWK storing MSISDN and IMSI in a MS context,

WiMAX AAA Server returning a RADIUS Access Accept message to GGSN via IWK,

performing a DHCP procedure, via IWK acting as DHCP relay and replacing MSISDN by NAI based IMSI in the client-identifier field to get an IP address corresponding to WiMAX Home Address HoA.

In another aspect, there is provided a method for 3GPP network entry using such architecture. In an embodiment, said method comprises a step of:

performing 3GPP network entry, using WiMAX R3 interface between IWK and WiMAX CSN.

In an embodiment, said method comprises the steps of:

upon MS attaching to the 3GPP network, setting up a PDP context with PPP type and APN mapping to IWK address with L2TP,

performing EAP procedure between MS and WiMAX AAA Server via IWK acting as an Authenticator,

performing DHCP procedure between IWK and WiMAX DHCP Server.

In an embodiment, said method comprises a step of:

during said EAP procedure, AAA Server sending to IWK Mobile Station MS context information including Home Address HoA, Home Agent Address HA@, DHCP Servers addresses DHCP@, and Mobile IP MIP keys.

In an embodiment, said method comprises the steps of:

upon attaching to the 3GPP network, MS requesting IP non-transparent PDP context, with APN mapping to IWK address,

performing DHCP procedure between GGSN and WiMAX DHCP Server via IWK acting as a DHCP relay, IWK mapping IMSI to WiMAX MAC address, and DHCP Server allocating MS IP address corresponding to WiMAX Home Address HoA.

In an embodiment, said method comprises a step of:

MS storing said allocated IP address.

In addition to such architecture and methods, the present invention also provides different entities, such as in particular interworking node IWK, 3GPP Packet Core Network entity such as GGSN, Mobile Station MS, for such architectures and/or comprising means for performing such methods.

The detailed implementation of the above-mentioned means does not raise any special problem for a person skilled in the art, and therefore such means do not need to be more fully disclosed than has been made above, by their function, for a person skilled in the art.

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although embodiments of the present method and apparatus have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An architecture for interworking between WiMAX and 3GPP networks, said architecture comprising:
an interworking node IWK which connects with the 3GPP Packet Core Network using 3GPP Gi interface, and with the WiMAX Connectivity Service Network CSN using WiMAX R3 interface.

2. An architecture according to claim 1, wherein IWK interfaces with a GGSN in the 3GPP Packet Core Network using 3GPP Gi interface.

3. An architecture according to claim 1, wherein IWK comprises a Foreign Agent FA.

4. An architecture according to claim 1, wherein IWK comprises Proxy-AAA-Server, DHCP relay, and a Foreign Agent FA.

5. An architecture according to claim 1, wherein Home CSN is considered by GGSN as an ISP identified by a dedicated APN.

6. A method for handover between WiMAX and 3GPP networks using an architecture according to claim 1, comprising the steps of:
handover preparation,
handover execution.

7. A method according to claim 6, wherein a handover comprises the steps of:
IWK managing in a coordinated way handovers from/to WiMAX network, using WiMAX R4 interface.

8. A method according to claim 6, wherein the preparation of a handover from WIMAX to 3GPP comprises the steps of:
a Mobile Station MS sending to the WiMAX network a Handover Request MOB-MSHO-REQ message specifying in a BSID list a fake Base Station Identity BS ID associated with IWK,
ASN-GW sending a R4 Handover Request R4 HO_Req message to IWK.

9. A method according to claim 6, wherein the preparation of a handover from WIMAX to 3GPP comprises a step of:
IWK storing in a Mobile Station MS context, WiMAX context information received in a R4 Handover Request R4 HO_Req message.

10. A method according to claim 6, wherein the preparation of a handover from WiMAX to 3GPP comprises a step of:
IWK storing in a Mobile Station MS context, WiMAX context information received in a R4 Anchor_DPF_Req message.

11. A method according to claim 9, wherein said WiMAX context information comprises Home Address HoA, Home Agent Address HA @, and Mobile IP MIP keys.

12. A method according to claim 6, wherein said handover preparation comprises a step of:
setting up a GRE tunnel between ASN-GW and IWK.

13. A method according to claim 6, wherein the execution of a handover from WiMAX to 3GPP comprises the steps of:
upon attaching to the 3GPP network, a Mobile Station MS performing PDP context setup towards IWK, MS requesting an IP address using either PPP or non-transparent PDP context type,
IWK resolving the PDP context setup using the WiMAX Home Address HoA associated with the MS in a MS Context stored in IWK.

14. A method according to claim 6, wherein the execution of a handover from WiMAX to 3GPP comprises the steps of:
upon attaching to 3GPP network, a Mobile Station MS sending a MOB_HO-IND message to the WiMAX network,
ASN-GW sending a R4 Handover Confirmation R4 HO_CNF message to IWK,
upon the forwarding of data by ASN-GW to IWK through a GRE tunnel, IWK sending a PDP PDU to GGSN,
GGSN initializing a Network-Requested PDP context activation procedure.

15. A method according to claim 6, wherein the execution of a handover from WiMAX to 3GPP comprises a step of:
upon a Mobile Station MS attaching to 3GPP network, setting up a PDP context of IP non-transparent type and with static mode, MS requiring to use previously stored WiMAX Home Address HoA.

16. A method according to claim 6, wherein the execution of a handover from WiMAX to 3GPP comprises the steps of:
IWK requesting FA relocation to ASN-GW,
ASN-GW providing in reply the necessary MIP keys to be used to update the current FA-HA registration.

17. A method according to claim 6, wherein the preparation of a handover from 3GPP to WiMAX comprises a step of:
a Mobile Station MS using a dedicated Signaling Agent to send a Handover Request to IWK.

18. A method according to claim 6, wherein the preparation of a handover from 3GPP to WiMAX comprises a step of:
IWK selecting a new Base Station Identity BS ID given its own fake BS ID and the WiMAX BS/ASN-GW topology configuration map.

19. A method for assigning a common IP address in WiMAX and 3GPP networks, comprising a step of:
retrieving a Mobile Station MS IP address from WiMAX network when providing the IP address to the MS in 3GPP network, transparently by IWK.

20. A method according to claim 19, comprising the steps of:
upon attaching to the 3GPP network, MS requesting non-transparent PDP Context creation, selecting IWK through APN field and providing its WiMAX Identity through the PCO field,
when handling the PDP context creation, GGSN building and sending a DHCP request to IWK, mapping the PCO field to a DHCP field,
IWK, acting as a DHCP relay or client, starting DHCP procedure towards WiMax DHCP Server,
IWK receiving the MS IP address from WiMax DHCP Server and delivering it to GGSN,
GGSN activating the PDP context with the MS IP address that is returned to the MS for configuration.

21. A method according to claim 19, comprising a step of:
constructing a Mobile Station MS context in IWK containing the MSISDN, IMSI and IP address of the MS for the usage of a DHCP server and Home Agent HA belonging to the WiMAX CSN.

22. A method according to claim 19, comprising the steps:
upon attaching to the 3GPP network, MS requesting non-transparent PDP Context creation, selecting IWK through APN,
upon receiving a Create PDP context Request message, GGSN sending a RADIUS Access Request message to WiMAX AAA Server, via S-IWK acting as proxy-AAA server, said message containing user's MSISDN and IMSI,
IWK storing MSISDN and IMSI in a MS context,
WiMAX AAA Server returning a RADIUS Access Accept message to GGSN via IWK,
performing a DHCP procedure, via IWK acting as DHCP relay and replacing MSISDN by NAI based IMSI in the client-identifier field to get an IP address corresponding to WiMAX Home Address HoA.

23. A method for 3GPP network entry, comprising a step of:
performing 3GPP network entry, using WiMAX R3 interface between IWK and WiMAX CSN.

24. A method according to claim 23, comprising the steps of:
upon MS attaching to the 3GPP network, setting up a PDP context with PPP type and APN mapping to IWK address with L2TP,
performing EAP procedure between MS and WiMAX AAA Server via IWK acting as an Authenticator,
performing DHCP procedure between IWK and WiMAX DHCP Server.

25. A method according to claim 24, comprising a step of:
during said EAP procedure, MA Server sending to IWK Mobile Station MS context information including Home Address HoA, Home Agent Address HA@, DHCP Servers addresses DHCP@, and Mobile IP MIP keys.

26. A method according to claim 23, comprising the steps of:
upon attaching to the 3GPP network, MS requesting IP non-transparent PDP context, with APN mapping to IWK address,
performing DHCP procedure between GGSN and WiMAX DHCP Server via IWK acting as a DHCP relay, IWK mapping IMSI to WiMAX MAC address, and DHCP Server allocating MS IP address corresponding to WiMAX Home Address HoA.

27. A method according to claim 24, comprising a step of:
MS storing said allocated IP address.

28. An Interworking node IWK for an architecture according to claim 1.

29. A 3GPP Packet Core Network entity such as in particular GGSN, for an architecture according to claim 1.

30. An Interworking node IWK according to claim 28, comprising means for performing at least one of handover preparation and execution, retrieving a Mobile Station MS IP address from WiMAX network when providing the IP address to the MS in 3GPP network transparently by IWK, or performing 3GPP network entry using WiMAX R3 interface between IWK and WiMAX CSN.

31. A 3GPP Packet Core Network entity such as in particular GGSN, comprising means for performing at least one of handover preparation and execution, retrieving a Mobile Station MS IP address from WiMAX network when providing the IP address to the MS in 3GPP network transparently by IWK, or performing 3GPP network entry using WiMAX R3 interface between IWK and WiMAX CSN.

32. A Mobile Station MS, comprising means for performing at least one of handover preparation and execution, retrieving a Mobile Station MS IP address from WiMAX network when providing the IP address to the MS in 3GPP network transparently by IWK, or performing 3GPP network entry using WiMAX R3 interface between IWK and WiMAX CSN.
